(19) United States
(12) Patent Application Publication
(10) Pub. No.: US 2014/0168253 A1
(43) Pub. Date: Jun. 19, 2014

(54) COLOR PROCESSING APPARATUS AND METHOD

(71) Applicant: CANON KABUSHIKI KAISHA, Tokyo (JP)

(72) Inventors: Kimitaka Arai, Yokohama-shi (JP); Yoshihiro Manabe, Yokohama-shi (JP)

(73) Assignee: CANON KABUSHIKI KAISHA, Tokyo (JP)

(21) Appl. No.: 14/101,932

(22) Filed: Dec. 10, 2013

(30) Foreign Application Priority Data
Dec. 18, 2012 (JP) 2012-276125
Dec. 18, 2012 (JP) 2012-276126
Apr. 1, 2013 (JP) 2013-076457

(51) Int. Cl. G09G 5/06

(52) U.S. Cl. CPC G09G 5/06
USPC 345/593

(57) ABSTRACT

A color processing apparatus comprises a storage which stores color information of a reference sample and the color characteristic of a monitor, a patch control unit which generates a plurality of color patch data having different colors based on the color information of the reference sample, and changes at least some of the plurality of color patch data based on a user instruction, and a patch output unit which corrects the plurality of color patch data based on the color characteristic of the monitor to output the plurality of corrected color patch data to the monitor. The patch control unit determines whether to acquire a color matching relation in a combination of the reference sample and the color patch data. When it is determined to acquire the color matching relation, the color matching relation in the combination is stored in the storage.

### BACKGROUND OF THE INVENTION

1. Field of the Invention

The present invention relates to color processing of acquiring a human visual characteristic.

2. Description of the Related Art

Human visual sensitivities to color appearance are standardized as a color matching function by Commission Internationale de l'Eclairage (CIE). General color matching uses a method of converting the colors of matching target devices (for example, a printer and display) into numerical values using this CIE color matching function, and making the colors numerically match each other.

However, the human visual sensitivities have individual differences, and the CIE color matching function adopts the average value of a plurality of examinees. For this reason, it is known that the visual sensitivity of a person does not always match the CIE color matching function.

Japanese Patent Laid-Open No. 2010-268294 (literature 1) discloses a method of performing color matching in consideration of the visual characteristic of a personal. According to the technique in literature 1, in order to consider the individual difference of the visual characteristic, a color matching experiment is conducted for each person so that the colors of color patches on a printed material match those of color patches displayed on a monitor. Based on the result of the color matching experiment, a transformation matrix is generated to obtain a display color corresponding to each person. An image is converted using the transformation matrix, thus implementing color management which absorbs the individual difference.

In the color matching experiment, for an inexperienced user to adjust color, it is hard to determine a direction in which display colors are adjusted to make color patches on a printed material and display colors match each other. For such users, an optimum experimental result is not always obtained. As a matter of course, even an experienced user to adjust color needs to perform color adjustment by trial and error, putting a heavy burden.

In the color matching experiment, it is necessary to determine a slight difference in color in the vicinity of the limit of color discrimination. It is therefore difficult to determine whether color adjustment has reached an optimum solution. Color adjustment may be repeated endlessly or converge to a local solution (failure value) different from a color matching point.

Further, a color conversion technique based on characteristics of color appearance of a user is proposed. According to this technique, the characteristics of the user are acquired by performing an experiment for comparing a plurality of color patches with corresponding display colors. Then, a lookup table (LUT) for converting colors into the display colors corresponding to the user is generated based on the characteristics acquired in the experiment, and an image is converted using the LUT so as to realize the color management which absorbs the individual differences.

However, adjustment error of the observer is contained in the comparative experiment of colors. The human vision has the characteristic that it is difficult to discriminate the difference of luminance as the luminance is high, it is impossible to discriminate the slight brightness of the lightness direction. If the color conversion is performed based on the experimental results containing an error in the lightness direction, there is a possibility that the contrast is reversed such extreme cases, deterioration of tonality is occurred.

### SUMMARY OF THE INVENTION

In one aspect, a color processing apparatus for acquiring a color matching relation between different devices, the apparatus comprising: a storage unit configured to store color information of a reference sample and a color characteristic of a display device; a patch control unit configured to generate a plurality of color patch data having different colors based on the color information of the reference sample, and change at least some of the plurality of color patch data based on a user instruction; and a patch output unit configured to correct the plurality of generated or changed color patch data based on the color characteristic of the display device to output the plurality of corrected color patch data to the display device, wherein the patch control unit determines, based on a user instruction, whether to acquire a color matching relation in a combination of the reference sample and the color patch data, and wherein, if it is determined to acquire the color matching relation, the color matching relation in the combination is stored in the storage unit by the patch control unit.

According to the aspect, a color matching relation between different devices can be easily acquired at high accuracy.

In another aspect, a color processing apparatus for generating a profile for making color appearances match each other, the apparatus comprising: an acquisition unit configured to acquire brightness information and color information, wherein the acquisition unit refers to a first color signal and second color signal obtained in a case where a user determines that a reference color output from a first image output apparatus based on the first color signal and an adjustment color output from a second image output apparatus based on the second color signal match each other, and a storage device which stores a colorimetric value of the reference color and a colorimetric value of the adjustment color, acquires the brightness information of the reference color from the colorimetric value of the reference color, and acquires the brightness information and the color information of the adjustment color from the colorimetric value of the adjustment color; a correction unit configured to correct the brightness information of the adjustment color using the brightness information of the reference color, and calculate a corrected colorimetric value of the adjustment color from the corrected brightness information of the adjustment color and the acquired color information of the adjustment color; and a generation unit configured to generate, from the first color signal, the second color signal, the colorimetric value of the reference color, and the corrected colorimetric value of the adjustment color, a profile for making color appearances in the first image output apparatus and the second image output apparatus match each other.

According to the other aspect, image deterioration caused by an error in the lightness direction in the color matching experiment is prevented, and a profile for making color appearances match each other can be generated.

Further features of the present invention will become apparent from the following description of exemplary embodiments with reference to the attached drawings.

### BRIEF DESCRIPTION OF THE DRAWINGS

FIG. 1 is a block diagram showing the arrangement of an information processing apparatus which executes color processing in an embodiment.

FIG. 2 is a block diagram for explaining the processing arrangement of a color processing apparatus in the embodiment.

FIG. 3 is a view exemplifying a UI displayed on a monitor by the color processing apparatus.

FIG. 4 is a graph schematically showing the positional relationship between peripheral colors when a center color is defined as the origin of the a*b* plane.

FIGS. 5 and 6 are flowcharts for explaining color processing to be executed by the color processing apparatus.

FIG. 7 is a table exemplifying a personal color matching data table.

FIG. 8 is a state transition chart for explaining the relationship between a user instruction and transition of processing.

FIG. 9 is a view showing a state in which the color patches of display colors near a color matching point are repetitively selected endlessly.

FIG. 10 is a flowchart for explaining a change of the chromaticity value of a center color in the second embodiment.

FIG. 11 is a state transition chart for explaining the relationship between a user instruction and transition of processing in the second embodiment.

FIG. 12 is a view exemplifying a UI in the third embodiment.

FIG. 13 is a state transition chart for explaining the relationship between a user instruction and transition of processing in the third embodiment.

FIG. 14 is a block diagram for explaining the arrangement of a patch control unit in the fourth embodiment.

FIGS. 15 to 17 are flowcharts for explaining color processing to be executed by a color processing apparatus in the fourth embodiment.

FIGS. 18A to 18D are views each schematically showing the relationship between the chromaticities of respective color patches and the chromaticity of a chart perceived by the user.

FIG. 19 is a state transition chart for explaining the relationship between a user instruction and transition of processing in the fourth embodiment.

FIG. 20 is a flowchart for explaining color processing to be executed by a color processing apparatus in the fifth embodiment.

FIG. 21 is a state transition chart for explaining the relationship between a user instruction and transition of processing in the fifth embodiment.

FIG. 22 is a diagram for explaining an outline of a color matching experiment using two image output apparatuses.

FIG. 23 is a diagram for explaining the arrangement of a color processing apparatus in the sixth embodiment.

FIG. 24 is a flowchart for explaining personal profile generation processing in the sixth embodiment.

FIG. 25 is a table exemplifying a table in which a color signal and color measurement signal after correction processing are recorded in the sixth embodiment.

FIG. 26 is a block diagram for explaining the arrangement of a color processing apparatus in the seventh embodiment.

FIG. 27 is a flowchart for explaining personal profile generation processing in the seventh embodiment.

FIG. 28 is a flowchart for explaining estimation processing of a tonality estimation unit in the seventh embodiment.

### DESCRIPTION OF THE EMBODIMENTS

Color processing according to embodiments of the present invention will now be described in detail with reference to the accompanying drawings.

### First Embodiment

[Apparatus Arrangement]

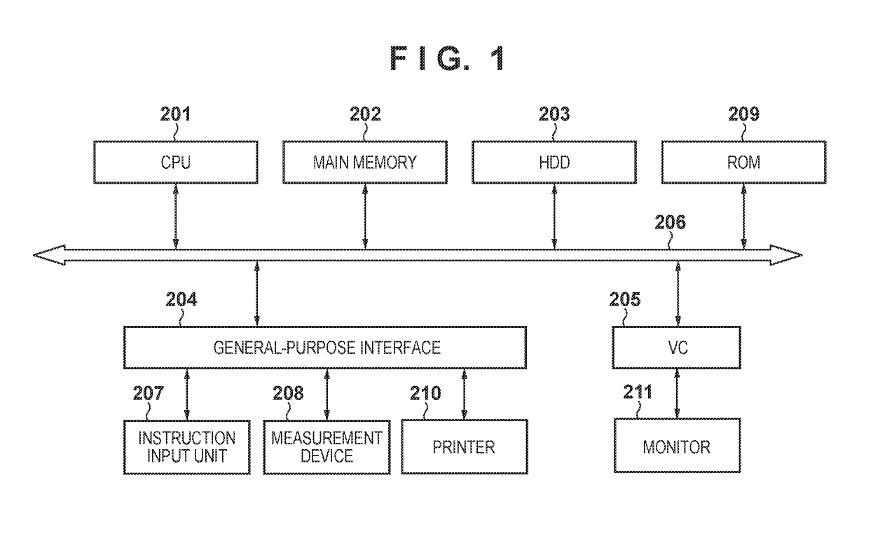

The arrangement of an information processing apparatus which executes color processing in the embodiment will be described with reference to the block diagram of FIG. 1.

A microprocessor (CPU) 201 executes programs stored in a read only memory (ROM) 209 or hard disk drive (HDD) 203 using, as a work memory, a main memory 202 such as a random access memory (RAM), and controls an arrangement (to be described later) through a system bus 206. Note that the ROM 209 and HDD 203 store programs and various data for implementing color processing (to be described later).

An instruction input unit 207 including a keyboard and pointing device, a measurement device 208, a printer 210, and the like are connected to a general-purpose interface (I/F) 204 such as a USB (Universal Serial Bus) or IEEE1394 interface. A monitor 211 is connected to a video card (VC) 205. The CPU 201 displays, on the monitor 211, a user interface (UI) and information representing the processing progress and processing result.

For example, the CPU 201 loads an application program (AP) stored in the ROM 209, the HDD 203, or a recording medium into a predetermined area of the main memory 202 in accordance with a user instruction input through the instruction input unit 207. Then, the CPU 201 executes the AP to display a UI on the monitor 211 in accordance with the AP.

After that, the CPU 201 loads various data stored in the HDD 203 into a predetermined area of the main memory 202 in accordance with an operation to the UI by the user. The CPU 201 performs predetermined arithmetic processing for various data loaded into the main memory 202 in accordance with the AP. The CPU 201 displays the arithmetic processing result on the monitor 211 or stores it in the HDD 203 in accordance with an operation to the UI by the user.

Note that the CPU 201 can also transmit/receive programs, data, arithmetic processing results to/from a server apparatus on the network through a network I/F (not shown) connected to the system bus 206.

[Processing Arrangement]

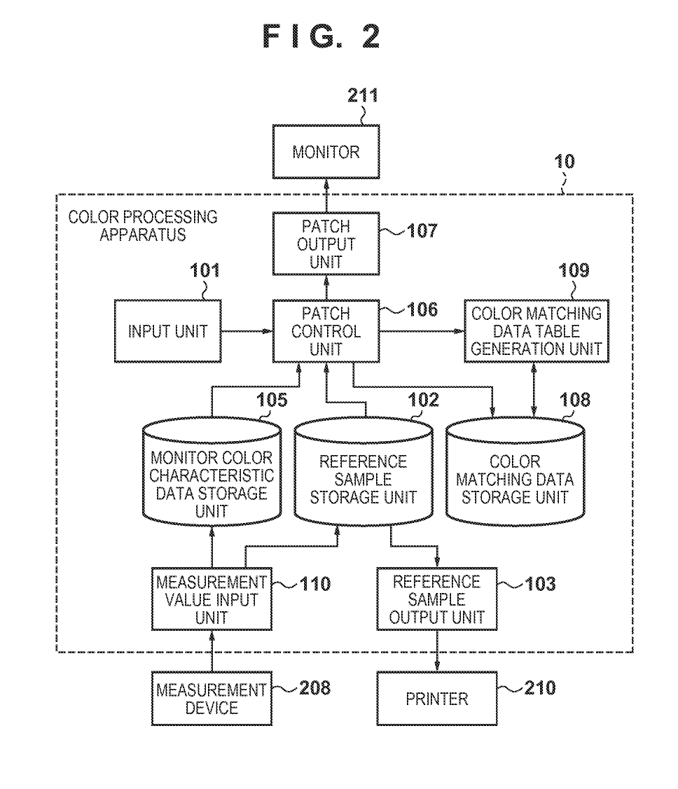

The processing arrangement of a color processing apparatus 10 in the embodiment will be explained with reference to the block diagram of FIG. 2. Note that the arrangement shown in FIG. 2 is implemented by executing an AP by the CPU 201. In the following description, color processing will be explained, in which the color processing apparatus 10 performs a color matching experiment between different devices (for example, a printer and monitor), and generates a color matching data table corresponding to the visual characteristic of a person.

In FIG. 2, a patch control unit 106 sets, in a patch output unit 107, color characteristic data stored in a monitor color characteristic storage unit 105, generates color patch data based on color information of a reference sample stored in a reference sample storage unit 102, and outputs the generated color patch data to the patch output unit 107.

The patch control unit 106 changes color patch data in accordance with a user instruction input through an input unit 101 corresponding to the instruction input unit 207, and outputs the changed color patch data to the patch output unit 107. When it is determined based on a user instruction input through the input unit 101 that a color matching relation has been obtained, color patch data (color matching experiment result) at the time of the determination is stored in a color matching data storage unit 108 in correspondence with a reference sample, details of which will be described later.

The patch output unit 107 corrects input color patch data based on set color characteristic data, and outputs the corrected color patch data to the monitor 211. The monitor 211 displays a color patch corresponding to the input color patch data.

When a user instruction input through the input unit 101 represents output of a reference sample, a reference sample output unit 103 outputs, to the printer 210, reference sample data stored in the reference sample storage unit 102 and causes the printer 210 to print a reference sample.

After the end of the color matching experiment, a color matching data table generation unit 109 generates the personal color matching data table of a user based on a color matching experiment result stored in the color matching data storage unit 108, and stores the generated personal color matching data table in the color matching data storage unit 108.

A measurement value input unit 110 receives the measurement result of the monitor 211 from the measurement device 208 and stores, in the monitor color characteristic storage unit 105, color characteristic data representing the color reproduction characteristic of the monitor 211 based on the color measurement result. Also, the measurement value input unit 110 receives, from the measurement device 208, the color measurement result of a reference sample printed by the printer 210 and stores the color measurement result as the measurement value of the reference sample in the reference sample storage unit 102.

The monitor color characteristic storage unit 105, reference sample storage unit 102, and color matching data storage unit 108 are assigned to predetermined areas of the HDD 203. Note that color characteristic data stored in the monitor color characteristic storage unit 105 and a measurement value stored in the reference sample storage unit 102 can be acquired using the measurement device 208, and can also be acquired from an external server apparatus or the like.

[User Interface]

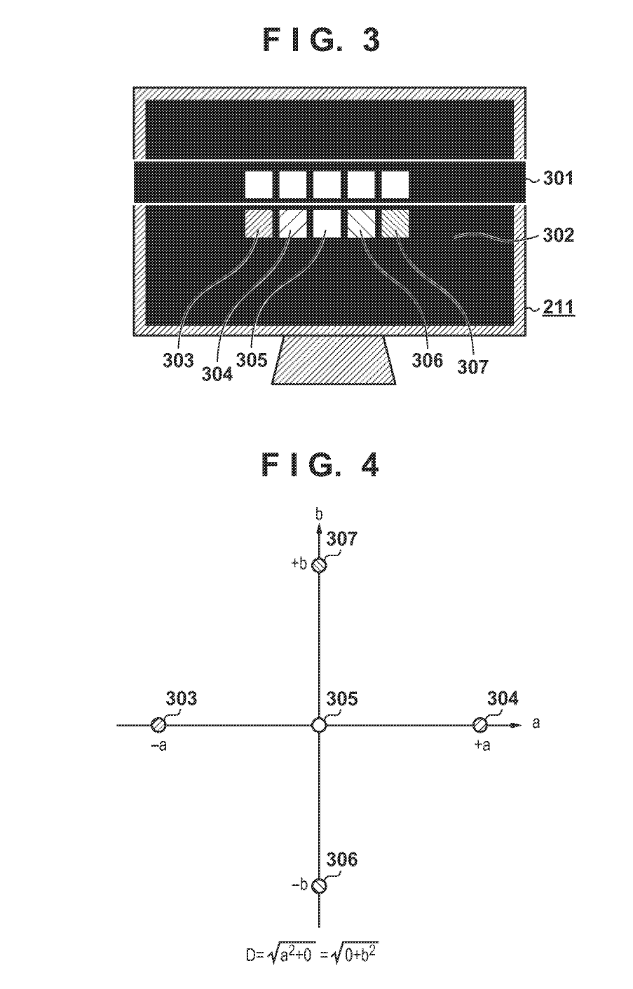

FIG. 3 exemplifies a UI displayed on the monitor 211 by the color processing apparatus 10.

A chart 301 is the chart of a reflective manuscript corresponding to reference sample data printed by the printer 210, that is, a reference sample. A plurality of color patches included in the chart 301 have the same color.

A color patch display unit 302 displays a plurality of color patches. A color patch at the center corresponds to a currently selected color (to be referred to as a center color hereinafter) 305, and the remaining four color patches correspond to colors (to be referred to as peripheral colors hereinafter) 303, 304, 306, and 307 near the center color 305.

FIG. 4 schematically shows the positional relationship between the peripheral colors when the center color 305 is defined as the origin of the a*b* plane. When the chromaticity of the center color 305 is defined as (0, 0), the peripheral color 303 has a chromaticity of (−a, 0), the peripheral color 304 has a chromaticity of (+a, 0), the peripheral color 306 has a chromaticity of (0, −b), and the peripheral color 307 has a chromaticity of (b, 0), as shown in FIG. 4. A color difference D between the center color 305 and each peripheral color is given by the following equation:

D=√(a²+0)=√(0+b²) (1)

All color differences between the center color 305 and the respective peripheral colors are assumed to be D. However, the color difference along the a-axis may be Da, and that along the b-axis may be Db (≠Da). The color differences of the respective peripheral colors from the center color 305 may be different from each other. Here, an example in which color patches displayed on the monitor 211 are a combination of one point (center color 305) in the Lab space and its peripheral colors will be explained. However, the present invention is not limited to this. That is, another color space may be used as long as a plurality of colors are combined as a center color and peripheral colors.

[Color Processing]

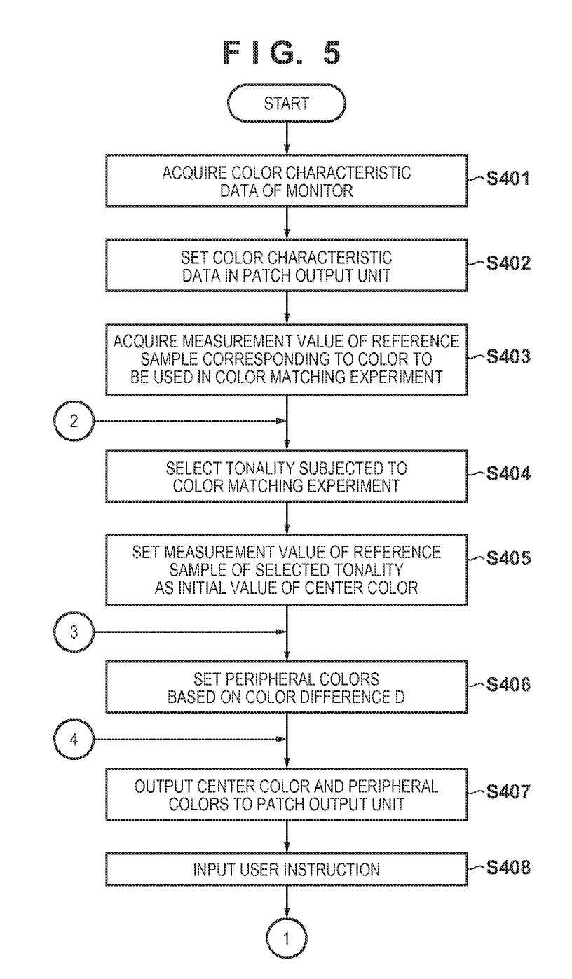

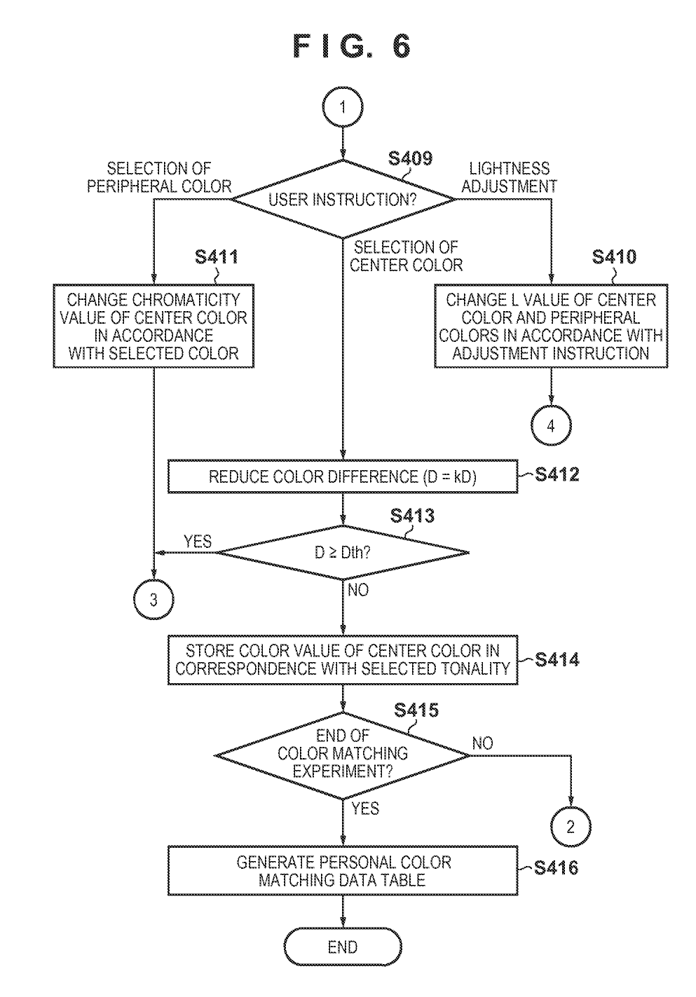

Color processing to be executed by the color processing apparatus 10 will be explained with reference to the flowcharts of FIGS. 5 and 6.

The patch control unit 106 acquires color characteristic data of the monitor 211 from the monitor color characteristic storage unit 105 (S401), and sets the acquired color characteristic data in the patch output unit 107 (S402).

Then, the patch control unit 106 acquires, from the reference sample storage unit 102, the measurement value of a reference sample corresponding to a color used in the color matching experiment (S403). Note that an arbitrary color and an arbitrary number of colors printable as color patches, such as the N tonalities of gray (for example, N=1 to 255), and primary and secondary colors (RGBCMY), are usable in the color matching experiment. For descriptive convenience, an example in which four tonalities of gray are used in the color matching experiment will be explained. In the following description, the terms “tonality” and “color” are used in the same sense without discrimination.

The patch control unit 106 selects a tonality subjected to the color matching experiment (S404), and sets the measurement value of a reference sample of the selected tonality as the initial value of the center color 305 (S405). That is, the center color 305 is set as the same color as that of the reference sample of the selected tonality. Letting Lₚaₚbₚ be the measurement value of the color patch of the selected tonality, the Lab value L_{c}a_{c}b_{c} of the center color 305 is given by the following equation:

(L_{C},a_{C},b_{C})=(L_{P},a_{P},bₚ)

Thereafter, the patch control unit 106 sets the peripheral colors 303, 304, 306, and 307 (S406). The Lab values of the respective peripheral colors are given by the following expressions of adding or subtracting a predetermined color difference D to or from the center color 305:

peripheral color 303: (L_{C},a_{C}−D,b_{C})

peripheral color 304: (L_{C},a_{C}+D,b_{C})

peripheral color 306: (L_{C},a_{C},b_{C}−D)

peripheral color 307: (L_{C},a_{C},b_{C}+D) (3)

The patch control unit 106 outputs the Lab values of the center color 305 and peripheral colors 303, 304, 306, and 307 to the patch output unit 107 (S407). Upon receiving the Lab values, the patch output unit 107 corrects them based on color characteristic data, and displays five color patches on the UI of the monitor 211 based on the corrected Lab values (see FIG. 3).

The user arranges the chart 301 corresponding to the selected tonality on the upper side (or lower side) of the color patch display unit (see FIG. 3), and compares the colors of the five color patches displayed on the UI with the color of the chart 301. Immediately before the comparison, the patch control unit 106 displays, on the UI, information (for example, a chart name or chart number) representing the chart corresponding to the selected tonality. The user can appropriately select and use the chart 301 to be compared.

After that, the patch control unit 106 receives a user instruction through the input unit 101 (S408), and determines the contents of the user instruction (S409). If the user instruction represents lightness adjustment (S409), the patch control unit 106 changes the L value of the center color 305 and peripheral colors 303, 304, 306, and 307 in accordance with an adjustment instruction input together with the user instruction (S410), and returns the process to step S407. The changed Lab values are output to the patch output unit 107, and the lightnesses of the five color patches displayed on the UI are adjusted.

If the user instruction represents selection of a peripheral color (S409), the patch control unit 106 changes the chromaticity value ab of the center color 305 in accordance with the selected peripheral color (to be referred to as a “selected color” hereinafter) in the following way (S411), and returns the process to step S406. The Lab values of the respective peripheral colors are changed in response to the change of the chromaticity of the center color 305. The changed Lab values are output to the patch output unit 107, and the center color and peripheral colors displayed on the UI are changed:

if (selected color == peripheral color 303) {

a_{C} = a_{C} − D;
b_{C} = b_{C};

}
if (selected color == peripheral color 304) {

a_{C} = a_{C} + D;
b_{C} = b_{C};

}
if (selected color == peripheral color 306) {

a_{C} = a_{C};
b_{C} = b_{C} − D;

}
if (selected color == peripheral color 307) {

a_{C} = a_{C};
b_{C} = b_{C} + D;

| | |
|---|---|
| } | . . . (4) |

If the user instruction represents selection of the center color 305 (S409), the patch control unit 106 reduces the color difference D to kD (0<k<1) (S412), and determines whether the reduced color difference D is equal to or larger than a threshold Dth (S413). If the reduced color difference D is equal to or larger than the threshold Dth (D≧Dth), the patch control unit 106 returns the process to step S406. The chromaticity values ab of the respective peripheral colors are changed based on the reduced color difference D. The changed Lab values are output to the patch output unit 107, and only the chromaticities of some color patches, that is, peripheral colors displayed on the UI are changed.

If the reduced color difference D is smaller than the threshold Dth (D<Dth), the patch control unit 106 determines that the selected tonality processing end condition is satisfied, and advances the process to step S414. As the threshold Dth, a color difference (in other words, color resolution of the monitor 211) reproducible when a signal value to be supplied to the monitor 211 is changed by one level is used. Alternatively, the range of the values of color difference grades, for example, AAA tolerance to B tolerance defined by Japan Color Research Institute, or an ordinarily used color difference (for example, a color difference of 1.0) may be used as the threshold Dth.

If the selected tonality processing end condition is satisfied, the patch control unit 106 stores the color value Lab of the center color 305 in the color matching data storage unit 108 in correspondence with the selected tonality (S414). Then, the patch control unit 106 determines whether all tonalities used in the color matching experiment have been selected (S415). If there is an unselected (unprocessed) tonality, the patch control unit 106 returns the process to step S404, selects the next tonality, and repeats the processes in steps S404 to S414. If the patch control unit 106 determines that processing (color matching experiment) of all tonalities has ended, it notifies the color matching data table generation unit 109 of the end of the color matching experiment.

Upon receiving the color matching experiment end notification, the color matching data table generation unit 109 generates a personal color matching data table based on data stored in the color matching data storage unit 108. The generated personal color matching data table is stored in the color matching data storage unit 108 in association with the user (S416), and the process ends.

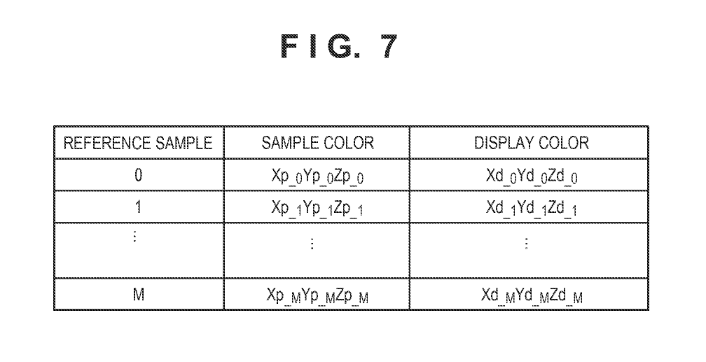

FIG. 7 exemplifies the personal color matching data table. The personal color matching data table shown in FIG. 7 represents, by the number of tonalities used in the color matching experiment, the correspondence (color matching relation) between the color value (sample color) of the chart 301 of a reflective manuscript and the color value (display color) of gray on the monitor 211. Although FIG. 7 shows an example in which an XYZ value is recorded, it suffices to record information representing a color, such as a Lab value or sRGB value. If necessary, the personal color matching data table may include environmental conditions (for example, illumination light, surrounding conditions, and specifying information of the monitor 211) in the color matching experiment in accordance with, for example, a user instruction.

[State Transition]

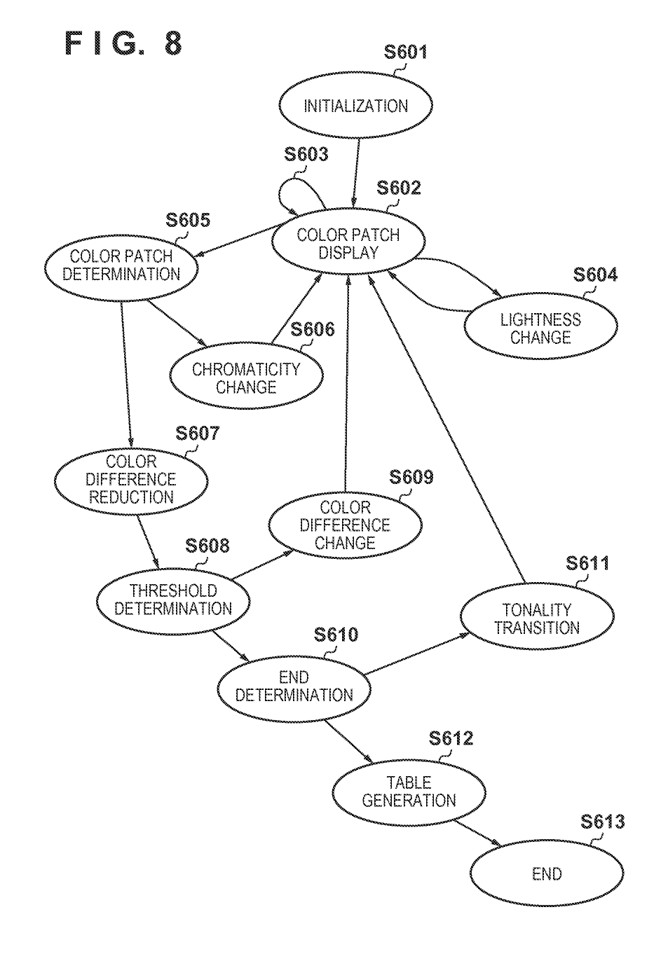

The relationship between a user instruction and transition of processing will be explained with reference to the state transition chart of FIG. 8.

In initialization (S601), the patch control unit 106 performs setting of color characteristic data of the monitor 211 in the patch output unit 107, acquisition of the measurement value of a color patch used in the color matching experiment, selection of the first tonality, setting of a center color and peripheral colors, and the like. In color patch display (S602), the patch control unit 106 displays the color patch on the UI or updates the color patch displayed on the UI, and waits for input of a user instruction (S603).

If the input user instruction represents a change of the lightness, the patch control unit 106 changes the L values of the center color and peripheral colors in lightness change (S604), and returns to state S602.

If the user instruction represents selection of a color patch, the patch control unit 106 determines, in color patch determination (S605), whether the selected color patch is the center color or peripheral color. If the peripheral color is selected, the patch control unit 106 changes the chromaticities of the center color and peripheral colors in chromaticity change (S606), and returns to state S602. If the center color is selected, the patch control unit 106 reduces the color difference D to kD (0<k<1) in color difference reduction (S607). In threshold determination (S608), the patch control unit 106 compares the reduced color difference D with the threshold Dth. If D≧Dth, the patch control unit 106 changes the chromaticities of the peripheral colors in color difference change (S609), and returns to state S602.

If D<Dth, the patch control unit 106 determines, in end determination (S610), whether processing of all tonalities (color matching experiment) used in the color matching experiment has ended. If there is an unprocessed tonality, the patch control unit 106 selects the next tonality in tonality transition (S611), sets a center color and peripheral colors corresponding to the selected tonality, and returns to state S602.

After the end of the color matching experiment, the color matching data table generation unit 109 generates a personal color matching data table in table generation (S611), and ends the process (S612).

As described above, in the color matching experiment in which the user compares a display color on the monitor with the color of a chart, the display color is controlled in accordance with a user instruction. Thus, the user need not adjust the display color by himself, and the color matching experiment result can be easily obtained at high accuracy without difficult color adjustment by the user, or trial and error of color adjustment.

### Second Embodiment

Color processing according to the second embodiment of the present invention will be described. In the second embodiment, the same reference numerals as those in the first embodiment denote the same parts, and a detailed description thereof will not be repeated.

The first embodiment has explained a method of displaying a plurality of color patches and narrowing down a color matching point in accordance with a color patch selection result by the user. However, a displayed color patch does not always become a display matching a color matching point. In this case, the color patches of display colors near the color matching point may be repetitively selected endlessly.

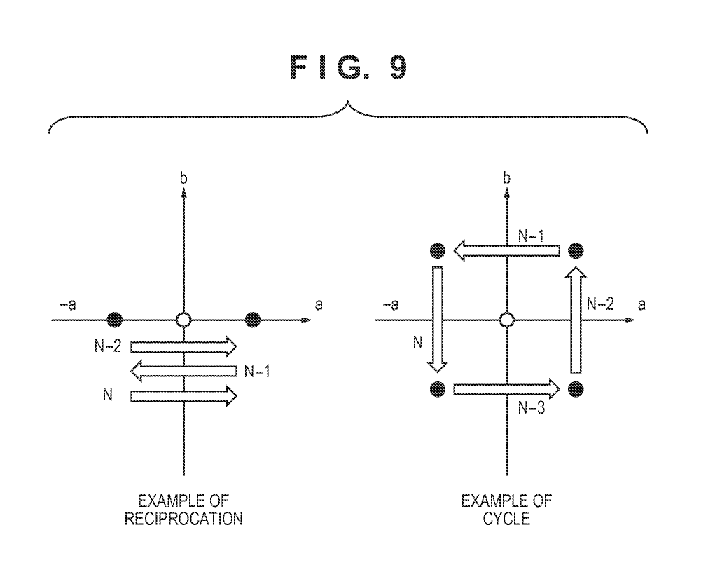

FIG. 9 shows a state in which the color patches of display colors near a color matching point are repetitively selected endlessly. In FIG. 9, an open circle ◯ indicates a color matching point, a filled circle indicates the color of a selected color patch, an arrow indicates repetition, and N represents the selection count. That is, reciprocal selection in which the colors of two color patches are alternately selected, cyclic selection in which the colors of three or more color patches are cyclically selected, or the like may occur. Owing to such repetitive selection, the color matching experiment may not end. The second embodiment will explain a method of converging the color matching experiment by controlling a center color in consideration of repetitive selection.

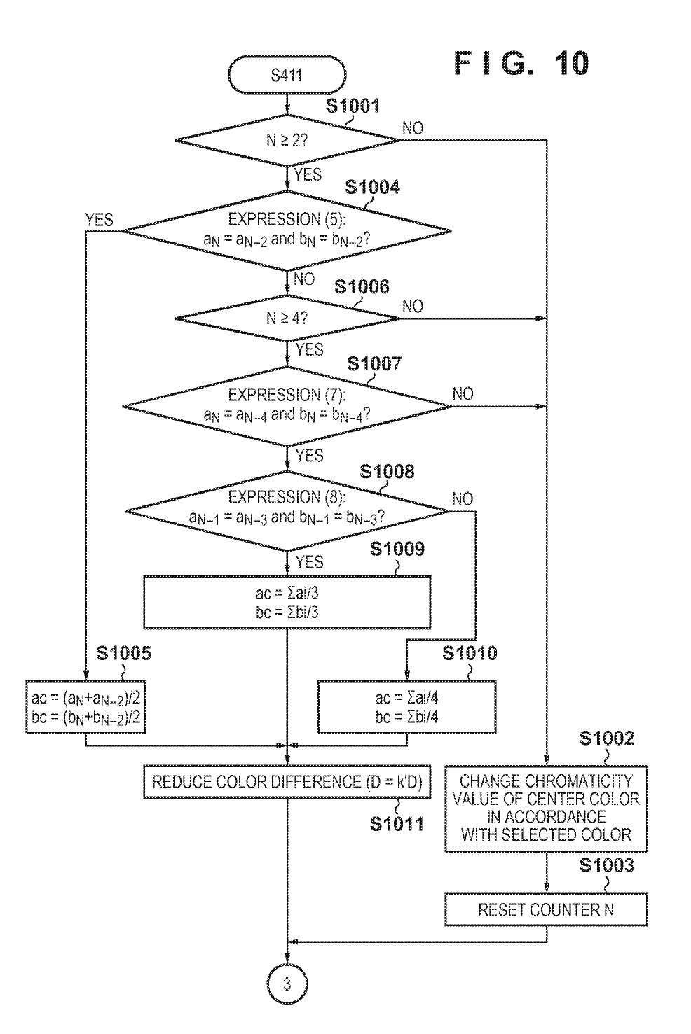

Color processing according to the second embodiment is different in that the chromaticity value of a center color is not simply changed in accordance with a selected color in step S411 (see FIG. 6). The change (S411) of the chromaticity value of a center color in the second embodiment will be described with reference to the flowchart of FIG. 10. Note that a counter N represents the color patch selection count by the user, and is reset to 0 at least every time tonality selection in the color matching experiment is performed (S404). A patch control unit 106 assigns the counter N to a main memory 202 and stores, in a predetermined area of the main memory 202, the color value Lab of a peripheral color selected by the user in the Nth selection, and the like.

The patch control unit 106 determines the count value N (S1001). If N<2, the patch control unit 106 changes the chromaticity value of the center color in accordance with a selected color (S1002), resets the counter N (S1003), and returns the process to step S406.

If N≧2, the patch control unit 106 makes the determination of expression (5) based on the chromaticity values ab of peripheral colors selected in the Nth and (N−2)th selections (S1004). If expression (5) is satisfied, the patch control unit 106 calculates the changed chromaticity value of the center color in accordance with expression (6) (S1005), and advances the process to step S1011:

| | |
|---|---|
| if (a_{N} == a_{N-2} && b_{N} == b_{N-2}) { | . . . (5) |

a_{C} = (a_{N} + a_{N-2})/2;
b_{C} = (b_{N} + b_{N-2})/2;

| | |
|---|---|
| } | . . . (6) |

If expression (5) is not satisfied, the patch control unit 106 determines the count value N (S1006). If N<4, the patch control unit 106 changes the chromaticity value of the center color in accordance with a selected color (S1002), resets the counter N (S1003), and returns the process to step S406.

If expression (5) is not satisfied and N≧4, the patch control unit 106 makes the determination of expression (7) based on the chromaticity values ab of peripheral colors selected in the Nth and (N−4)th selections (S1007). If expression (7) is satisfied, the patch control unit 106 subsequently makes the determination of expression (8) based on the chromaticity values ab of peripheral colors selected in the (N−1)th and (N−3)th selections (S1008). If expression (8) is satisfied, the patch control unit 106 calculates the changed chromaticity value of the center color in accordance with expression (9) (S1009). If expression (8) is not satisfied, the patch control unit 106 calculates the changed chromaticity value of the center color in accordance with expression (10) (S1010), and advances the process to step S1011:

| | |
|---|---|
| if (a_{N} == a_{N-4} && b_{N} == b_{N-4}) { | . . . (7) |

| | |
|---|---|
| if (a_{N} == a_{N-4} && b_{N} == b_{N-4}) { | . . . (8) |

a_{C} = Σaᵢ/3;
b_{C} = Σbᵢ/3;

| | |
|---|---|
| } | . . . (9) |

else {

a_{C} = Σaᵢ/4;
b_{C} = Σbᵢ/4;

| | |
|---|---|
| } | . . . (10) |

}
where, i = N, N−1, N−2 in expression (9),

and

i = N, N−1, N−2, N−3 in expression

(10).

If expression (7) is not satisfied, the patch control unit 106 changes the chromaticity value of the center color in accordance with a selected color (S1002), resets the counter N (S1003), and returns the process to step S406. In the respective cases “N<2”, “expression (5) is not satisfied and N<4”, and “N 4 and expression (7) is not satisfied”, the same processing as that in step S411 of the first embodiment is performed except for resetting of the counter N.

When the average value of the chromaticities of repetitively selected peripheral colors is calculated in step S1005, S1009, or S1010, the patch control unit 106 reduces the color difference D to k′D (0<k′<1) (S1011), and returns the process to step S406. Note that the coefficients k and k′ are set to have, for example, a relation of k′ k.

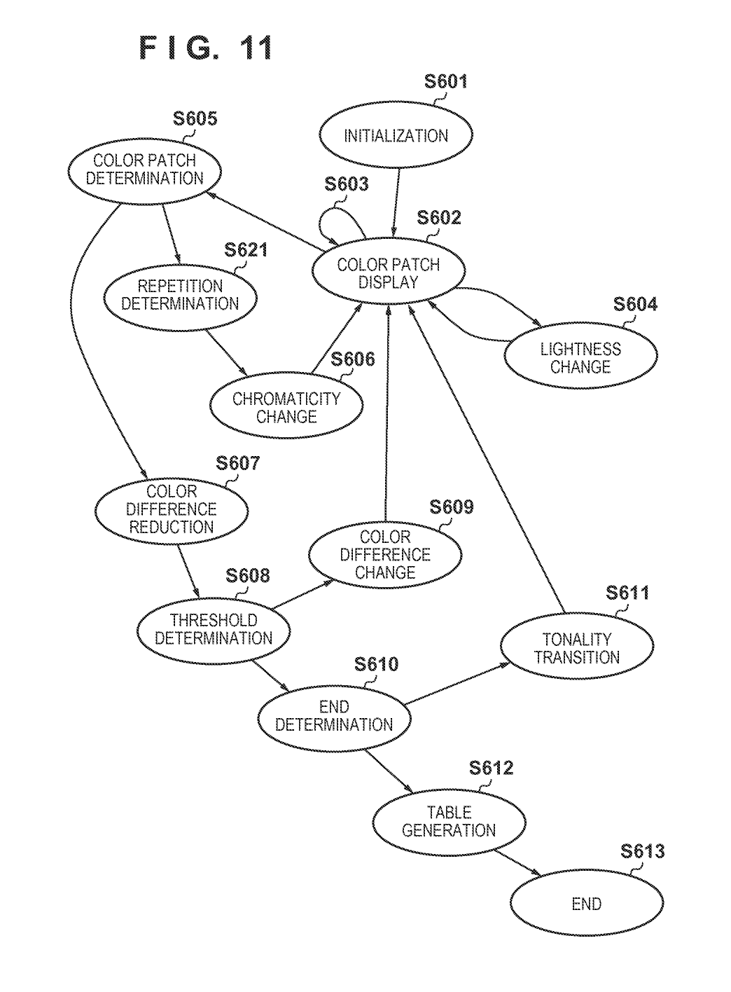

The relationship between a user instruction and transition of processing in the second embodiment will be explained with reference to the state transition chart of FIG. 11. The state transition chart in the second embodiment is different from the state transition chart (FIG. 8) in the first embodiment in that repetition determination (S621) for determining repetition of color patch selection shown in FIG. 10 is inserted between color patch determination (S605) for determining whether the selected color patch is a center color or peripheral color, and chromaticity change (S606) performed when a peripheral color is selected. As shown in FIG. 10, the chromaticity value of the center color is changed in chromaticity change (S606) in accordance with the result of repetition determination (S621).

In this manner, the color of a displayed color patch can be controlled based on the result of repetition determination so that the color matching experiment converges.

### Third Embodiment

Color processing according to the third embodiment of the present invention will be described. In the third embodiment, the same reference numerals as those in the first and second embodiments denote the same parts, and a detailed description thereof will not be repeated.

The first embodiment has explained a method of displaying a plurality of color patches and narrowing down a color matching point in accordance with a color patch selection result by the user. The second embodiment has explained a method of controlling the color of a color patch not to repeat color patch selection. However, the user may not be able to select a combination in which the color of a reflective manuscript and the display color best match each other, and may select (erroneously select) a color patch which is not satisfactorily matched. If an erroneous selection occurs, the colors of all displayed color patches shift in a direction in which no matching is obtained. Time may be taken till reach to a color matching point, or reach to a color matching point may become difficult, failing to reach the color matching point. The third embodiment will explain a method of, when the user erroneously selects a color patch, returning to a state before the erroneous selection.

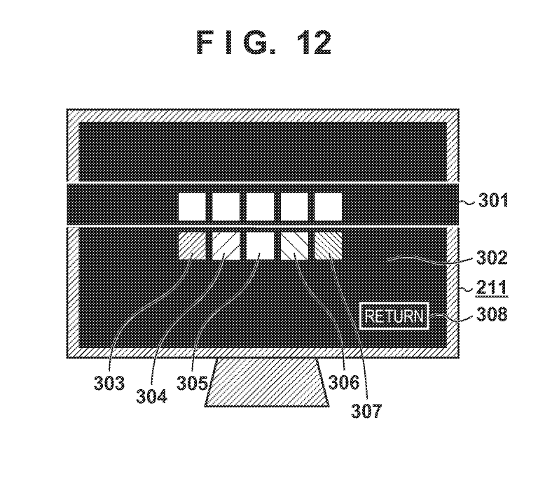

FIG. 12 exemplifies a UI in the third embodiment. The UI in the third embodiment includes a “return” button 308. If the user clicks the button 308, a patch control unit 106 returns the colors of displayed color patches to colors before a change by processing in immediately preceding step S406 or S410. Instead of displaying the “return” button 308 on the UI, the user may designate the return function for the colors of color patches by performing a keyboard operation to an instruction input unit 207.

In step S407, when outputting the color value of a center color to a patch output unit 107 in step S407, the patch control unit 106 holds, in a predetermined area of a main memory 202, the color value (immediately preceding color value) of the center color displayed on the UI at this time. If a user instruction to execute the return function is input from an input unit 101, the patch control unit 106 acquires the color value stored in the predetermined area of the main memory 202, sets the acquired color value as the center color, and returns the process to step S406. In response to the return of the center color, the Lab values of the respective peripheral colors are changed (S406). The changed Lab values are output to the patch output unit 107 (S407), and the center color and peripheral colors displayed on the UI are returned to immediately preceding colors.

The patch control unit 106 executes the return function as interrupt processing based on a user instruction. If the color value of a center color is stored in the main memory 202 every time the center color is changed after the initial value of the center color, the color of the color patch can be returned by the number of times designated by the user.

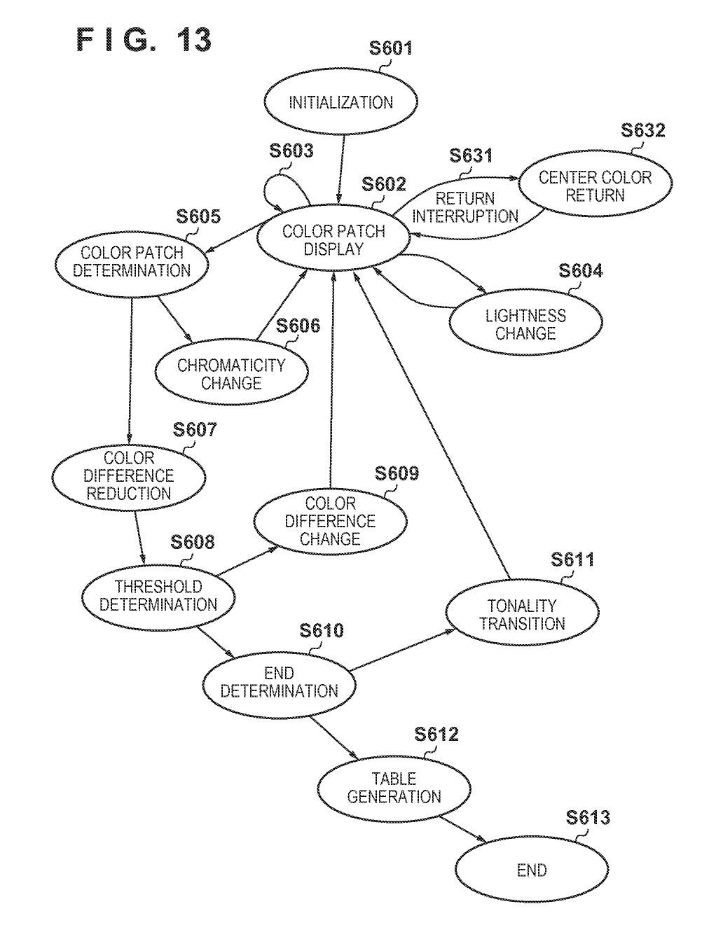

The relationship between a user instruction and transition of processing in the third embodiment will be explained with reference to the state transition chart of FIG. 13. The state transition chart in the third embodiment is different from the state transition chart (FIG. 8) in the first embodiment in that center color return (S632) by return interruption (S631) is added. More specifically, when return interruption (S631) occurs, the center color is returned in center color return (S632), and the state returns to color patch display (S602). As a result, the center color and peripheral colors displayed on the UI return to immediately preceding ones.

In this manner, the colors of color patches can be returned. Thus, when the colors of all displayed color patches shift in a direction in which no matching is obtained, they can be easily returned to a state before the erroneous selection.

### Fourth Embodiment

Color processing according to the fourth embodiment of the present invention will be described. In the fourth embodiment, the same reference numerals as those in the first to third embodiments denote the same parts, and a detailed description thereof will not be repeated.

[Patch Control Unit]

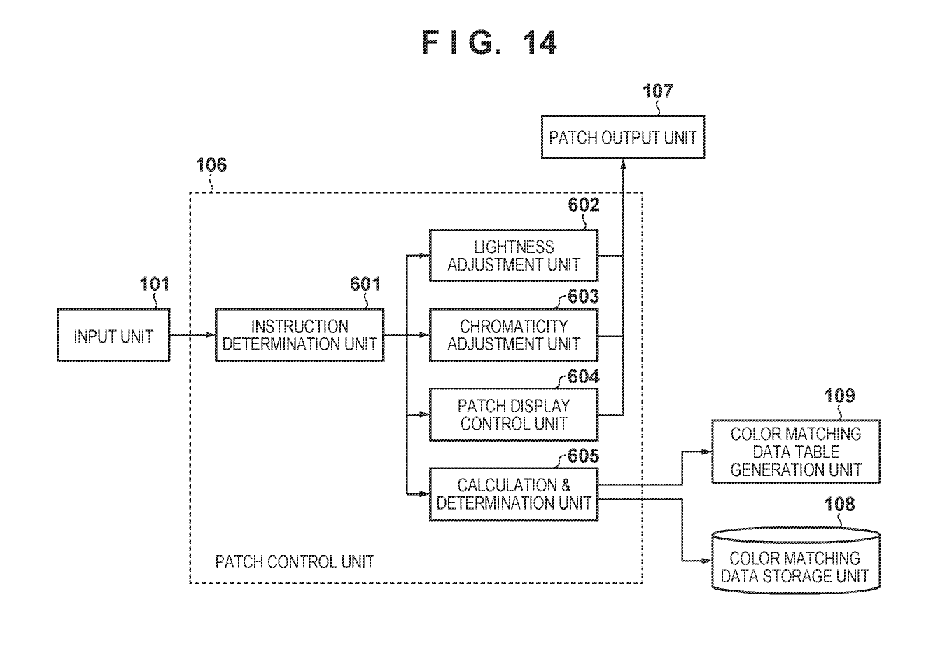

The arrangement of a patch control unit 106 in the fourth embodiment will be explained with reference to the block diagram of FIG. 14.

An instruction determination unit 601 determines the contents of a user instruction input through an input unit 101. As described above, the user instruction includes, for example, a lightness adjustment instruction, peripheral color selection instruction, center color selection instruction, color patch exclusion/return instruction, and color matching experiment continuation/end instruction.

A lightness adjustment unit 602 changes the lightness of a color patch when a lightness adjustment instruction is input. A chromaticity adjustment unit 603 changes the chromaticity of a color patch when a peripheral color selection instruction or center color selection instruction is input. A patch display control unit 604 performs color patch exclusion/return (to be described later) when a color patch exclusion/return instruction is input. A calculation & determination unit 605 performs calculation and determination (to be described later), and outputs a color matching experiment result.

[Color Processing]

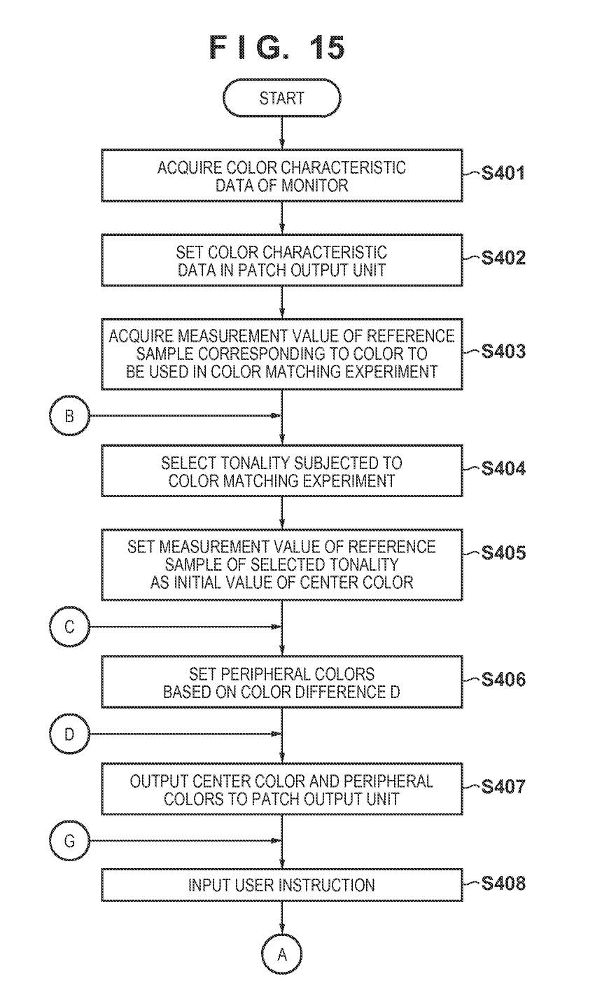

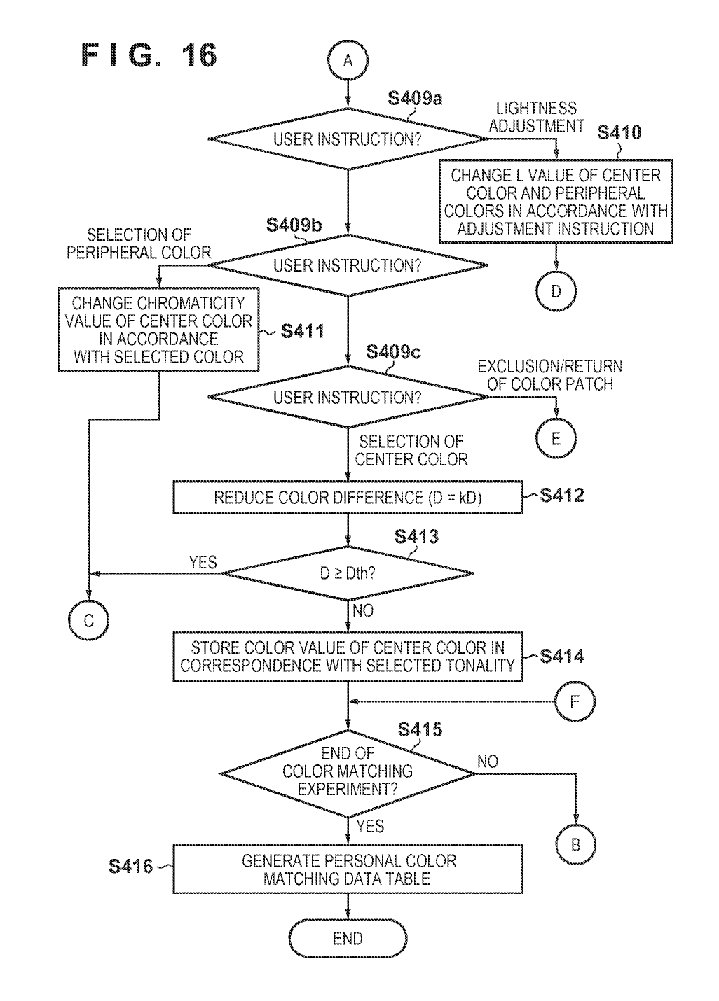

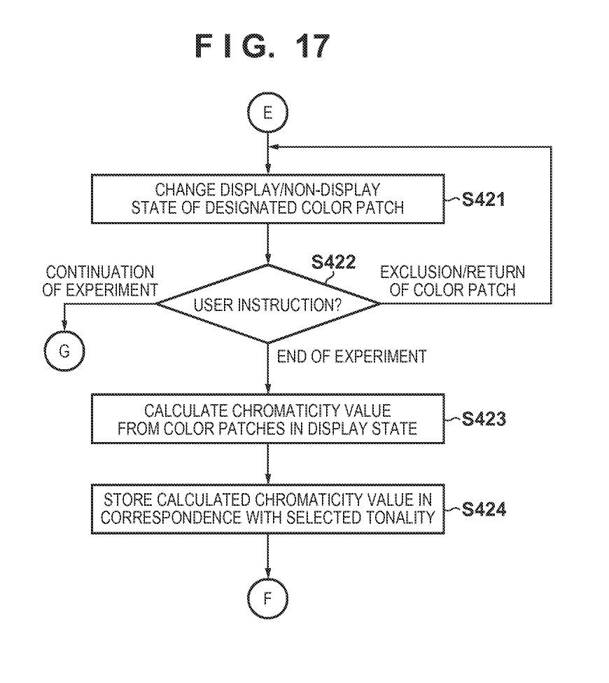

Color processing to be executed by a color processing apparatus 10 will be explained with reference to the flowcharts of FIGS. 15 to 17. The same reference numerals as those shown in FIGS. 5 and 6 denote the same processes, and a detailed description thereof will not be repeated.

The patch control unit 106 performs the same processes as those in steps S401 to S408 of FIG. 5, and determines the contents of a user instruction input through the input unit 101 (S409a-S409c). If the user instruction represents lightness adjustment (S409a), the patch control unit 106 changes the L value of a center color 305 and peripheral colors 303, 304, 306, and 307 in accordance with an adjustment instruction input together with the user instruction (S410), and returns the process to step S407. The changed Lab values are output to a patch output unit 107, and the lightnesses of the five color patches displayed on the UI are adjusted.

If the user instruction represents peripheral color selection (S409b), the patch control unit 106 changes the chromaticity value ab of the center color 305 in accordance with a selected color in accordance with expression (4) (S411), and returns the process to step S406. The Lab values of the respective peripheral colors are changed in response to the change of the chromaticity of the center color 305. The changed Lab values are output to the patch output unit 107, and the center color and peripheral colors displayed on the UI are changed.

If the user instruction represents selection of the center color 305 (S409c), the patch control unit 106 reduces the color difference D to kD (0<k<1) (S412), and determines whether the reduced color difference D is equal to or larger than a threshold Dth (S413). If the reduced color difference D is equal to or larger than the threshold Dth (D≧Dth), the patch control unit 106 returns the process to step S406. The chromaticity values ab of the respective peripheral colors are changed based on the reduced color difference D. The changed Lab values are output to the patch output unit 107, and only the chromaticities of some color patches, that is, peripheral colors displayed on the UI are changed.

If the reduced color difference D is smaller than the threshold Dth (D<Dth), the patch control unit 106 determines that the selected tonality processing end condition is satisfied, and advances the process to step S414. If the selected tonality processing end condition is satisfied, the patch control unit 106 stores the color value Lab of the center color 305 in a color matching data storage unit 108 in correspondence with the selected tonality (S414), and advances the process to step S415.

Consideration of Color Discrimination Limit

As the above-described color adjustment proceeds, the differences between a chart 301 and the colors of color patches and the differences between the colors of the respective color patches are decreased. Finally, the user needs to determine a small difference in color near the limit of color discrimination, and select a color patch. As described above, it is difficult to determine, near the limit of color discrimination, whether color adjustment has reached an optimum solution. Color adjustment may be repeated endlessly or converge to a local solution (failure value) different from a color matching point.

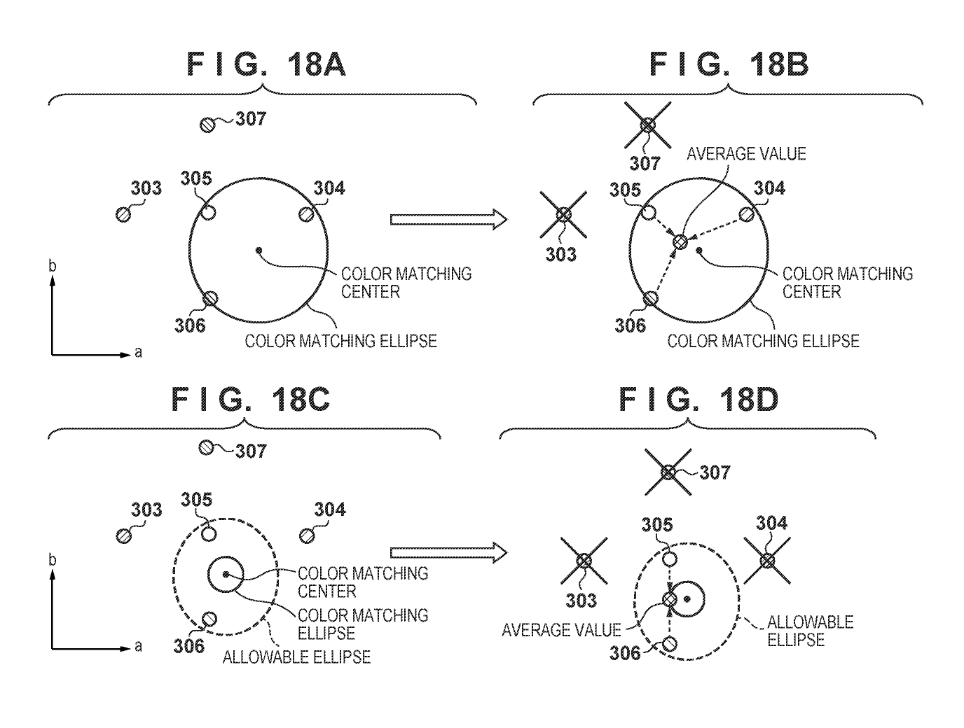

FIGS. 18A to 18D schematically show the relationship between the chromaticities of the respective color patches and the chromaticity of the chart 301 perceived by the user. In FIGS. 18A to 18D, the color matching center corresponds to the chromaticity of the chart 301 perceived by the user, and is a chromaticity which should be acquired in the color matching experiment. A color matching ellipse represents a discrimination limit at which the user cannot perceive the difference of a color from the color matching center.

FIG. 18A shows a case in which there are a plurality of color patches close to an optimum value. The user cannot perceive the differences between the center color 305 and peripheral colors 304 and 306 inside the color matching ellipse, and the color matching center. In this case, the user may not be able to select an optimum value from a plurality of color patches inside the color matching ellipse, or may repetitively select a plurality of color patches inside the color matching ellipse.

FIG. 18C shows a case in which no color patch falls within the color matching ellipse and there are a plurality of color patches each having an allowable difference in color from the color matching center. In FIG. 18C, the allowable ellipse represents the limit by which the user can allow the difference of a color from the color matching center. In this case, the user may determine that there is no solution and may not be able to select a color patch. Color adjustment may converge to a local solution (color patch falling within the allowable range) different from an optimum value. Alternatively, the center color 305 or peripheral color 306 having a difference in color falling within the allowable range may be repetitively selected.

Also, FIG. 18C shows a case in which none of the center color 305 and peripheral colors falls within the color matching ellipse, and there is no color patch having a color which seems for the user to match the color of the chart 301. In the state shown in FIG. 18C, if the user selects the center color 305, the peripheral color 306 may come close to the color matching center. However, the user does not always select the center color 305. In this case, color adjustment may be repeated.

To prevent this, in the fourth embodiment, color patch exclusion/return by the user is permitted. A chromaticity value close to the color matching center is acquired from the colors of color patches included in the color matching ellipses, as shown in FIG. 18B, or those of color patches included in the allowable ellipse, as shown in FIG. 18D.

FIG. 18B shows an example in which, when the center color 305 and peripheral colors 304 and 306 seem to match the color of the chart 301, the user excludes the color patches of the peripheral colors 303 and 307 (peripheral color with X marks), and acquires the average chromaticity value of the remaining center color 305 and peripheral colors 304 and 306. Similarly, FIG. 18D shows an example in which the user determines that the differences between the center color 305 and peripheral color 306 and the color of the chart 301 fall within the allowable range, excludes the color patches of the peripheral colors 303, 304, and 307 each having a difference in color falling outside the allowable range, and acquires the average chromaticity value of the remaining center color 305 and peripheral color 306. As shown in FIGS. 18B and 18D, a chromaticity value closer to the color matching center is highly likely to be acquired, compared to a case in which the chromaticity value of one color patch in the color matching ellipse or allowable ellipse is acquired.

In color processing according to the embodiment, color patch exclusion/return processing is performed in consideration of the color discrimination limit. More specifically, if the user instruction represents color patch exclusion/return (S409c), the patch control unit 106 changes the display/non-display state of a color patch for which exclusion/return is designated (S421). When a displayed color patch is designated, it is excluded (non-display state). When a position corresponding to a color patch in the non-display state is designated, the color patch at this position is returned (display state).

Then, the patch control unit 106 displays, on the UI, a message such as “Do you continue or end the color matching experiment for the current chart, or perform color patch exclusion/return?”, and waits for a response from the user (S422). If there is a response from the user to continue the color matching experiment, the patch control unit 106 returns the process to step S408. If the user designates color patch exclusion/return, the patch control unit 106 returns the process to step S421.

If there is a response from the user to end the color matching experiment, the patch control unit 106 calculates a chromaticity value from color patches in the display state in the following way (S423). The patch control unit 106 stores the calculated chromaticity value in the color matching data storage unit 108 in correspondence with the selected tonality (S424), and advances the process to step S415:

if (N == 5 or N == 0) {

a_{C} = a_{C};
b_{C} = b_{C};

} else {

a_{C} = Σᵢ₌₀^{N-1}aᵢ/N;
b_{C} = Σᵢ₌₀^{N-1}bᵢ/N;

| | |
|---|---|
| } | . . . (11) |

where N is the number of color patches in the display state, and
i is the index of a color patch in the display state (0 to N−1).

In expression (11), the number of color patches in the display state does not usually take N=0. However, N=0 is set in order to prevent loss of data corresponding to a selected tonality when the user excludes all color patches and designates the end of the color matching experiment for the current chart. Note that a message indicative of this is desirably recorded for a chromaticity value obtained at N=0.

If the selected tonality processing end condition is satisfied, or the end of the color matching experiment for the current chart is designated, the patch control unit 106 determines whether all tonalities used in the color matching experiment have been selected (S415). If there is an unselected (unprocessed) tonality, the patch control unit 106 returns the process to step S404, selects the next tonality, and repeats the above-described processes. If the patch control unit 106 determines that processing (color matching experiment) for all tonalities has ended, it notifies a color matching data table generation unit 109 of the end of the color matching experiment. Processing (S416) by the color matching data table generation unit 109 is the same as that in the first embodiment, and a detailed description thereof will not be repeated.

[State Transition]

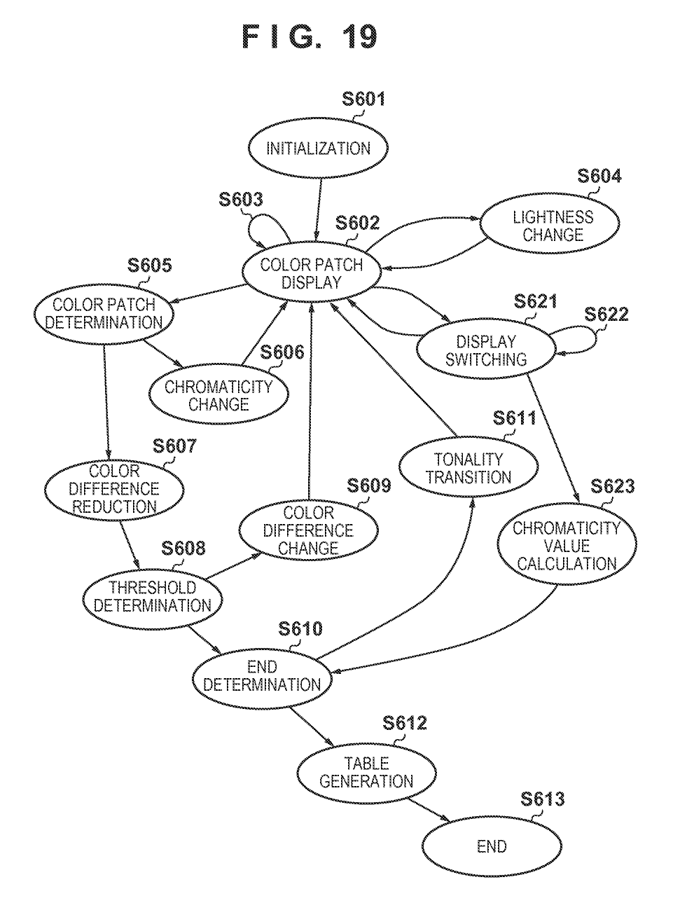

The relationship between a user instruction and transition of processing in the fourth embodiment will be explained with reference to the state transition chart of FIG. 19. Note that the same reference numerals as those shown in FIG. 8 denote the same processes, and a detailed description thereof will not be repeated.

The patch control unit 106 waits for input of a user instruction (S603). If the user instruction represents color patch exclusion/return, the patch control unit 106 switches the display/non-display state of a designated color patch in display switching (S621), and waits for input of a user instruction (S622). If the input user instruction represents color patch exclusion/return, the patch control unit 106 switches again the display/non-display state of a designated color patch in display switching (S621). If the user instruction represents continuation of the color matching experiment, the patch control unit 106 returns to state S602. If the user instruction represents the end of the color matching experiment, the patch control unit 106 calculates a chromaticity value from color patches in the display state in accordance with expression (11) in chromaticity value calculation (S623), stores the calculated chromaticity value, and advances to end determination (S610). Subsequent processes (S610-S612) are the same as those in the first embodiment, and a description thereof will not be repeated.

As described above, in the color matching experiment in which the user compares a display color on the monitor with the color of a chart, the display color is controlled in accordance with a user instruction. Therefore, the user need not adjust the display color by himself, and the color matching experiment result can be easily obtained at high accuracy without difficult color adjustment by the user, or trial and error of color adjustment.

Further, when the difference between a display color on the monitor and the color of a chart comes close to the color discrimination limit, the user can exclude a color patch of a color (not optimum color patch; to be referred to as an improper color patch hereinafter) which does not seem to be matched, and can designate the end of the color matching experiment. Hence, repetition of color adjustment and convergence to a local solution (failure value) by compromise, which arise from determination of a difference in color near the color discrimination limit, can be prevented.

### Fifth Embodiment

Color processing according to the fifth embodiment of the present invention will be described. In the fifth embodiment, the same reference numerals as those in the first to fourth embodiments denote the same parts, and a detailed description thereof will not be repeated.

The fourth embodiment has described a method of excluding an improper color patch by the user to prevent repetition of color adjustment and convergence to a local solution (failure value) by compromise, which arise from determination of a difference in color near the color discrimination limit. After excluding an improper color patch, the user checks whether an improper color patch exists in the remaining color patches, and if necessary, excludes the improper color patch again. However, this work is sometimes cumbersome.

The fifth embodiment will describe a method of simply excluding a color patch. More specifically, color patches (chromaticity value calculation target color patches) which are not improper color patches are selected at once from color patches, and the color matching experiment result is decided from the selection result.

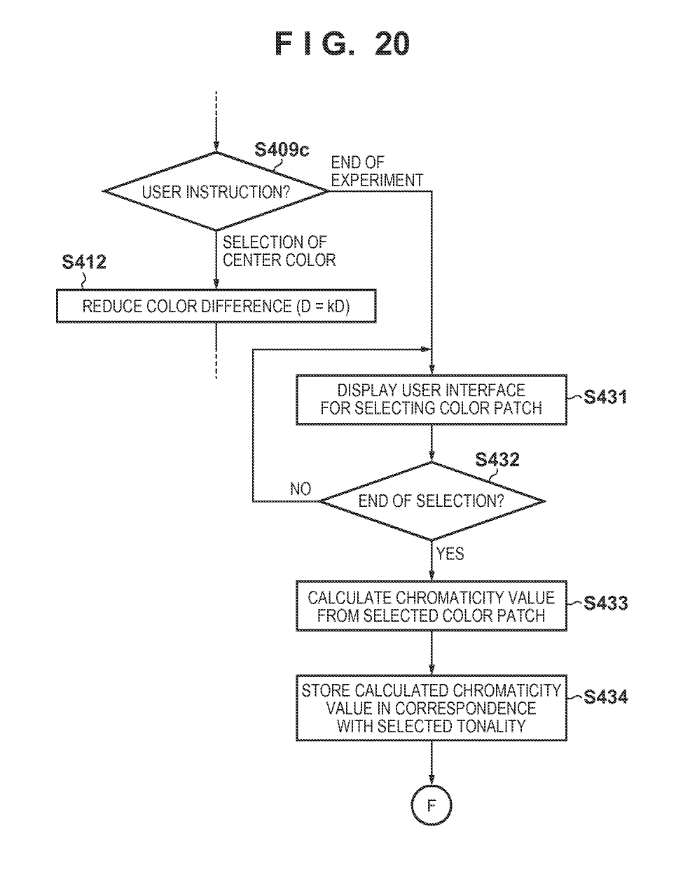

Color processing to be executed by a color processing apparatus 10 in the fifth embodiment will be explained with reference to the flowchart of FIG. 20. Note that processes in steps S401 to S409b and S410 to S416 are the same as those in the fourth embodiment, and a detailed description thereof will not be repeated.

If the user instruction represents the end of the color matching experiment (end of processing) in step S409c, for example, a patch control unit 106 displays, on the UI, a dialog (color patch selection user interface) including radio buttons corresponding to color patches 303 to 307 (S431). If the user selects a color patch and presses, for example, a “selection complete” button in the dialog (S432), the patch control unit 106 calculates a chromaticity value from the selected color patch in accordance with expression (11) (S433). The patch control unit 106 stores the calculated chromaticity value in a color matching data storage unit 108 in correspondence with the selected tonality (S434), and advances the process to step S415.

In step S431, after the user designates the completion of selection, it is also possible to hide unselected color patches, prompt the user to determine whether the selection is correct, and if the selection is incorrect, perform color patch selection again.

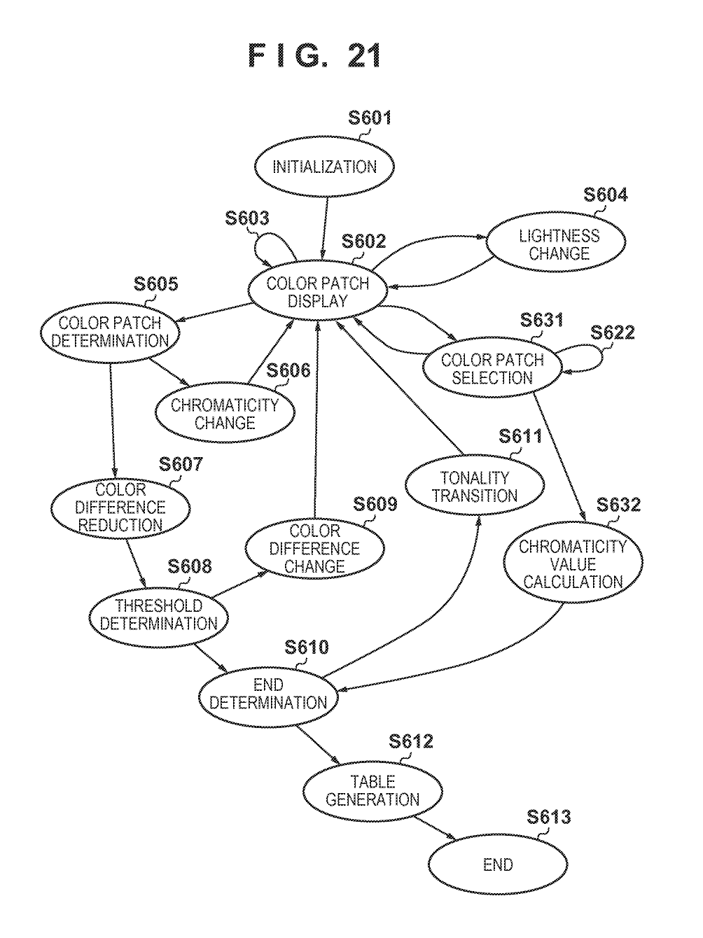

The relationship between a user instruction and transition of processing in the fifth embodiment will be explained with reference to the state transition chart of FIG. 21. The state transition chart in the fifth embodiment is different from the state transition chart (FIG. 19) in the fourth embodiment in that states S631 to S633 replace states S621 to S623.

More specifically, when the user instruction represents selection of a plurality of color patches, the patch control unit 106 displays the color patch selection user interface in color patch selection (S631), and waits for a selection completion instruction from the user (S632). If the selection completion instruction is input, the patch control unit 106 calculates a chromaticity value from the selected color patches in accordance with expression (5) in chromaticity value calculation (S633), stores the calculated chromaticity value, and advances to end determination (S610).

As described above, when the difference between a display color on the monitor and the color of a chart reaches the vicinity of the color discrimination limit, the user can designate the end of the color matching experiment, and designate color patches to be used for acquiring data representing a color matching relation. Accordingly, exclusion of color patches can be simplified, and repetition of color adjustment and convergence to a local solution (failure value) by compromise, which arise from determination of a difference in color near the color discrimination limit, can be prevented.

### Sixth Embodiment

Color processing according to the sixth embodiment of the present invention will be described. In the sixth embodiment, the same reference numerals as those in the first to fifth embodiments denote the same parts, and a detailed description thereof will not be repeated.

[Color Matching Experiment]

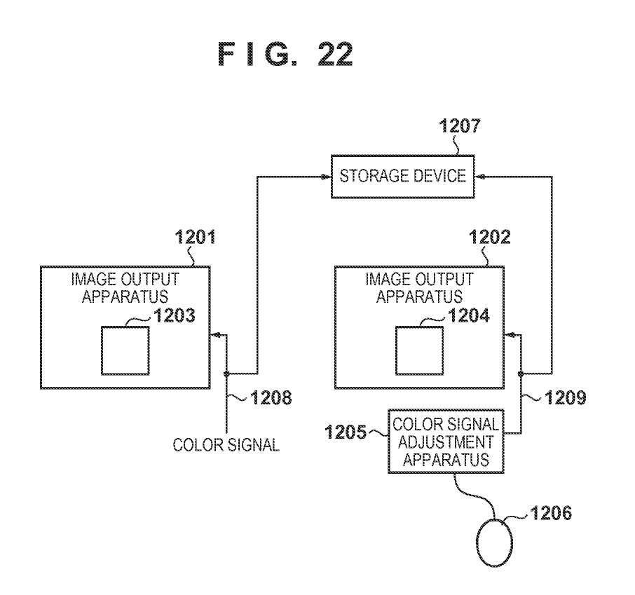

In the sixth embodiment, a personal profile is generated based on the result of a color matching experiment conducted in advance by the user. The color matching experiment by the user will be explained with reference to FIG. 22.

FIG. 22 shows an outline of a color matching experiment using two image output apparatuses. A first image output apparatus 1201 displays a color patch (to be referred to as a “reference color patch” hereinafter) 1203 serving as the reference of a color in accordance with a color signal 1208. A second image output apparatus 1202 is a color conversion processing target, and displays a color patch (to be referred to as an “adjustment color patch” hereinafter) 1204 to undergo color adjustment in accordance with a color signal 1209. A color signal adjustment apparatus 1205 adjusts the color signal 1209 to be supplied to the second image output apparatus 1202. The color signal adjustment apparatus 1205 includes an instruction input device 1206 including a mouse and keyboard for adjusting the color signal 1209.

Note that the first and second image output apparatuses are arbitrary devices, such as a monitor, printer, or projector, which output images based on color signals. The first and second image output apparatuses may be devices of the same type or devices of different types. For example, a color patch on a printed material is used as the reference color patch 1203, and the color of the adjustment color patch 1204 displayed on the monitor is adjusted.

The user adjusts the color signal 1209 on a UI provided by the color signal adjustment apparatus 1205 so that the color appearance of the adjustment color patch 1204 comes close to that of the reference color patch 1203. If the user determines that the color of the adjustment color patch 1204 matches that of the reference color patch 1203, he clicks, for example, a color matching button which is provided by the UI of the color signal adjustment apparatus 1205 and designates that color matching has been obtained. If the color matching button is clicked, the color signal 1208 (first color signal) and the corresponding color signal 1209 (second color signal) are stored in a storage device 1207, HDD 203, or a storage medium.

This color matching experiment is repetitively conducted for one or more arbitrary colors. The storage device 1207 stores color matching data (correspondence between the first and second color signals) by the number of experiments.

[Generation of Profile]

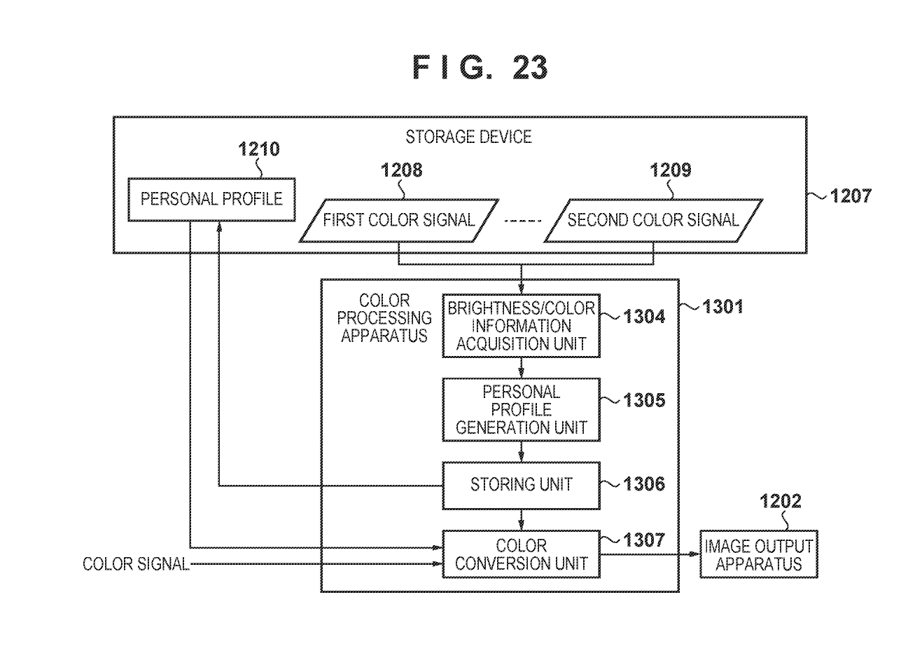

The arrangement of a color processing apparatus 1301 which generates a personal profile will be exemplified with reference to FIG. 23. Note that the arrangement shown in FIG. 23 is implemented by executing a color processing AP by a CPU 201.

A brightness/color information acquisition unit 1304 acquires brightness information and color information in the user observation environment that correspond to the first color signal 1208 and second color signal 1209 obtained by the color matching experiment. The brightness information and color information are stored in the storage device 1207 in correspondence with the first color signal 1208 and second color signal 1209, respectively, as colorimetric values obtained by measuring, by a measurement device 208, the reference color patch 1203 and adjustment color patch 1204 upon clicking the color matching button.

As for the brightness information and color information, the reference color patches 1203 and adjustment color patches 1204 corresponding to a plurality of color signals are displayed in advance in the color matching experiment environment (user observation environment), and stored in the storage device 1207 as colorimetric values obtained by measuring these color patches by the measurement device 208. The brightness/color information acquisition unit 1304 may perform interpolation calculation from these colorimetric values for brightness information and color information corresponding to the first color signal 1208 and second color signal 1209.

In the following description, the brightness information and color information will be explained as a luminance Lv and xy chromaticity, respectively. However, colorimetric values are arbitrary as long as the brightness and color are separated, such as L*a*b*, Luv, or Jab.

A personal profile generation unit 1305 generates a personal profile from the luminance Lv and xy chromaticity obtained by the brightness/color information acquisition unit 1304, details of which will be described later. A storing unit 1306 stores a generated personal profile 1210 in the storage device 1207 in association with user identification information. A color conversion unit 1307 corrects an input color signal using the personal profile 1210 which is stored in the storage device 1207 by the storing unit 1306 and corresponds to the user identification information. The color conversion unit 1307 then supplies the corrected color signal to the second image output apparatus 1202.

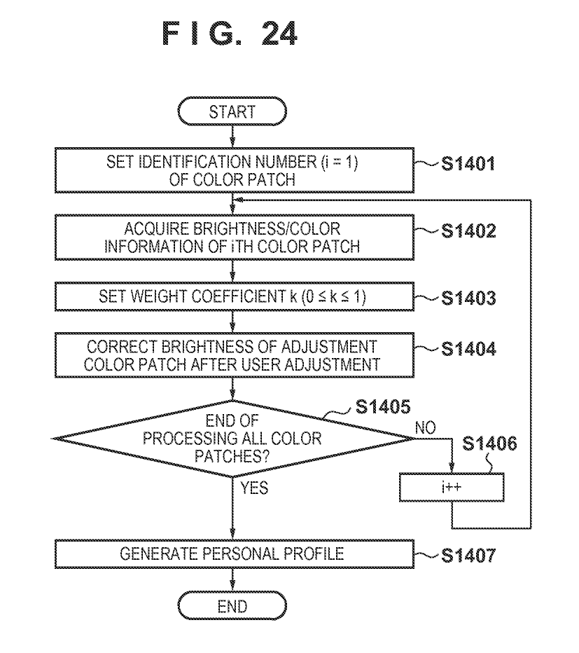

Personal profile generation processing in the sixth embodiment will be explained with reference to the flowchart of FIG. 24. Note that the personal profile generation unit 1305 of the color processing apparatus 1301 executes the personal profile generation processing.

The personal profile generation unit 1305 sets an identification number (i=1) for selecting the first color patch from target color patches (S1401), and acquires the luminance Lv and xy chromaticity of a color patch corresponding to the set identification number i by referring to the storage device 1207 (S1402). As for the ith color patch, Ly₁ᵢ, and x₁ᵢ and y₁ᵢ represent the luminance Lv and xy chromaticity of the reference color patch 1203 output from the first image output apparatus 1201. Also, Lv₂ᵢ, and x₂ᵢ and y₂ᵢ represent the luminance Lv and xy chromaticity of the adjustment color patch 1204 output from the second image output apparatus 1202 after user adjustment.

The personal profile generation unit 1305 sets the value of a weight coefficient kᵢ of the luminance Ly₁ᵢ of the reference color patch 1203 in order to correct the luminance Lv₂ᵢ of the adjustment color patch 1204 after user adjustment (S1403). Note that the weight coefficient k satisfies 0≦kᵢ≦1. Then, the personal profile generation unit 1305 corrects Lv₂ᵢ to Lv₂ᵢ′ by addition processing given by equation (12) (S1404):

Lv₂ᵢ′=kᵢ×Lv₁ᵢ+(1−kᵢ)×Lv₂ᵢ (12)

If the weight coefficient kᵢ is increased in equation (12), the ratio of Lv₁ᵢ of the reference color patch 1203 to Lv₂ᵢ′ becomes high, and the ratio of the luminance Lv₂ᵢ of the adjustment color patch 1204 after user adjustment becomes low. This is equivalent to reduction of the influence of an error accompanying user adjustment. If the weight coefficient kᵢ=1, the second term in equation (12) becomes 0. This is equivalent to replacing Lv₂ᵢ with Lv₁ᵢ.

Although the weight coefficient kᵢ is set for each color patch in the above example, the same weight coefficient k may be applied to all color patches. The average gain ΣLv₂ᵢ/ΣLv₁ᵢ of the luminance of the adjustment color patch 1204 after user adjustment with respect to the luminance of the reference color patch 1203 from all color patches may be used for correction. Correction is performed using the common weight coefficient k and average gain in accordance with equation (13):

Lv₂ᵢ′=k×Lv₁ᵢ+(1−k)×ΣLv₂ᵢ/ΣLv₁ᵢ (13)

Thereafter, the personal profile generation unit 1305 determines whether correction processing has been performed for all color patches (S1405). If correction processing has not ended for all color patches, the personal profile generation unit 1305 increments the identification number i (S1406), and returns the process to step S1402. If correction processing has ended for all color patches, the personal profile generation unit 1305 advances the process to step S1407.

If correction processing has ended for all color patches, the personal profile generation unit 1305 generates, based on the correspondence between Lv₁ᵢ, x₁ᵢ, and y₁ᵢ, and Lv₂ᵢ′, x₂ᵢ, and y₂ᵢ, a 3D LUT as a personal profile for converting the first color signal into the second color signal (S1407).

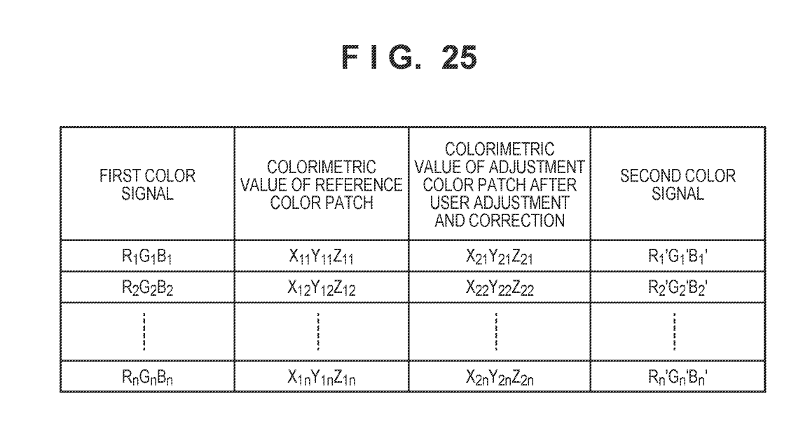

FIG. 25 exemplifies a table in which a color signal and color measurement signal after correction processing are recorded. This table includes the first color signal, the colorimetric value of the reference color patch 1203, the colorimetric value of the adjustment color patch 1204 after user adjustment and correction, and the second color signal corresponding to the colorimetric value after correction. The first color signal is the signal value of the reference color patch 1203 and is known. When the colorimetric value of the reference color patch 1203 measured by the measurement device 208 is not an XYZ value, X₁ᵢY₁ᵢZ₁ᵢ is calculated from, for example, Lv₁ᵢ, x₁ᵢ, and y₁ᵢ. The colorimetric value of the adjustment color patch 1204 after correction is calculated in accordance with equations (14):

x₂ᵢ=Lv₂ᵢ′×x₂ᵢ/y₂ᵢ;

Y₂ᵢ=Lv₂ᵢ′;

Z₂ᵢ=Lv₂ᵢ′×(1−x₂ᵢ−y₂ᵢ)/y₂ᵢ;

Then, X₂ᵢY₂ᵢZ₂ᵢ is converted into the second color signal based on a known RGB-XYZ characteristic of the second image output apparatus 1202.

Further, a 3D LUT is generated by calculating the correspondence between the first color signal and the second color signal at each of, for example, 9×9×9 RGB grid points, based on the relationship between the colorimetric value X₁ᵢY₁ᵢZ₁ᵢ of the reference color patch 1203 and the corresponding value X₂ᵢY₂ᵢZ₂ᵢ. Conversion from corresponding to the interpolation value of the first color signal into X₂′Y₂′Z₂′ uses equations (15):

X₂′=Σ(X₂ᵢ/X₁ᵢ)×X₁′/n;

Y₂=Σ(Y₂ᵢ/Y₁ᵢ)×Y₁′/n;

Z₂′=Σ(Z₂ᵢ/Z₁ᵢ)×Z₁′/n; (15)

where n is the number of color patches having undergone the color matching experiment.

In equations (15), the average value of the ratio of the colorimetric value sets (X₁ᵢY₁ᵢZ₁ᵢ and X₂ᵢY₂ᵢZ₂ᵢ) obtained by the color matching experiment is calculated, and this ratio is multiplied by X₁′Y₁′Z₁′.

Similar to the above-described processing, X₂′Y₂′Z₂′ is converted into the second color signal based on the known RGB-XYZ characteristic, thereby generating a 3D LUT.

Note that the form of the personal profile is not limited to a 3D LUT. For example, a transformation such as a gamma coefficient or matrix for converting the first color signal RGB into the second color signal R′G′B′, or a gain coefficient for RGB may be calculated and used as a personal profile.

In this manner, the brightness value of the adjustment color patch 1204 after user adjustment is corrected in the color matching experiment result using the brightness value of the reference color patch 1203. Hence, the influence of an error contained in user adjustment can be reduced, and color information having a large characteristic difference depending on a person (for example, color information of a color patch having a high luminance) can be corrected preferentially. As a result, degradation of the image quality, such as reversal of tonality, caused by an error contained in user adjustment can be suppressed.

Accordingly, degradation of the image quality caused by an error in the lightness direction in the color matching experiment can be prevented, and a profile for making color appearances match each other can be generated. In other words, the influence of an adjustment error in the color matching experiment can be reduced, and a personal profile for performing color conversion suited to the visual characteristic of each person can be generated.

When the value of the weight coefficient is set to be k=1, brightness information of the reference color patch 1203 is used as brightness information. While maintaining the brightness of the reference color patch 1203, only color information can be corrected for each user.

### Seventh Embodiment

Color processing according to the seventh embodiment of the present invention will be described. In the seventh embodiment, the same reference numerals as those in the first to sixth embodiments denote almost the same parts, and a detailed description thereof will not be repeated.

In the sixth embodiment, the luminance Lv₂ᵢ of the adjustment color patch 1204 in the user color matching experiment result is corrected to be Lv₂ᵢ′ using the weight coefficient k and the luminance Lv₁ᵢ of the reference color patch 1203. The seventh embodiment will describe an example in which, when the user color matching experiment result is directly applied, tonality degradation is evaluated and the luminance Lv₂ᵢ of an adjustment color patch 1204 is corrected in accordance with the evaluation result.

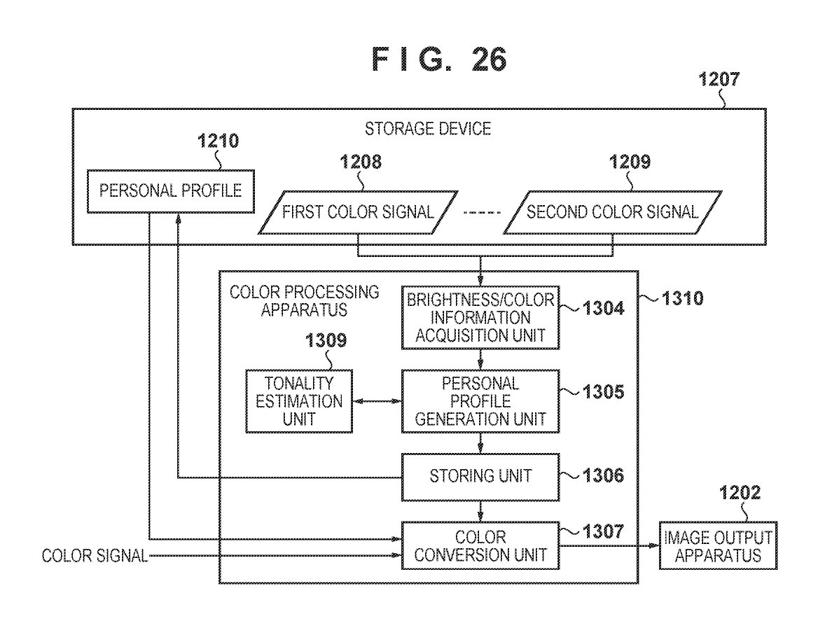

The arrangement of a color processing apparatus 1301 in the seventh embodiment will be exemplified with reference to the block diagram of FIG. 26. The color processing apparatus 1301 in the seventh embodiment is different from the color processing apparatus 1301 in the sixth embodiment shown in FIG. 23 in that it includes a tonality estimation unit 1309 configured to evaluate tonality degradation. The tonality estimation unit 1309 evaluates tonality degradation when a personal profile generation unit 1305 generates a personal profile. Based on the result of evaluation by the tonality estimation unit 1309, the personal profile generation unit 1305 decides the weight coefficient k to suppress tonality degradation.

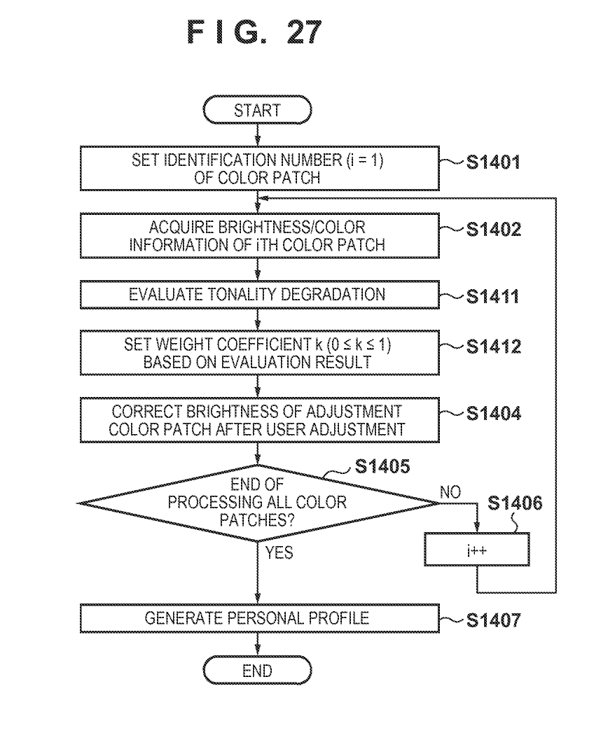

Personal profile generation processing in the seventh embodiment will be explained with reference to the flowchart of FIG. 27. The personal profile generation processing in the seventh embodiment is the same as the processing in the sixth embodiment shown in FIG. 24 except that the tonality estimation unit 1309 evaluates tonality degradation (S1411) and the personal profile generation unit 1305 decides the weight coefficient k based on the evaluation result (S1412).

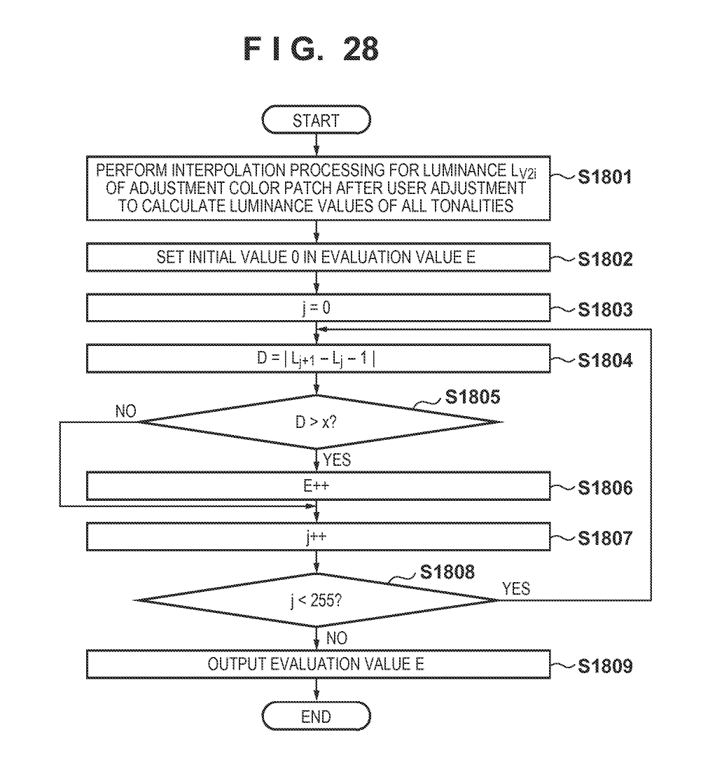

Estimation processing by the tonality estimation unit 1309 will be explained with reference to the flowchart of FIG. 28.

The tonality estimation unit 1309 performs interpolation processing for the luminance Lv₂ᵢ of the adjustment color patch 1204 after user adjustment to calculate luminance values for all tonalities (S1801). More specifically, the tonality estimation unit 1309 calculates the luminance Yᵢ of the second color signal from the signal value of the adjustment color patch 1204 after user adjustment in accordance with, for example, equations (16):

Rᵢ′=(R₁/255)^{2.2};

Gᵢ′=(G₁/255)^{2.2};

Bᵢ′=(B₁/255)^{2.2};

Yᵢ=0.299Rᵢ+0.587Gᵢ+0.114Bᵢ; (16)

For example, if the luminance Y is represented by 8 bits, the tonality estimation unit 1309 performs interpolation calculation for 256 luminance values Lⱼ (j=0 to 255) corresponding to the range of Y=0 to 255 in accordance with the correspondence between Yᵢ and Lv₂ᵢ. The interpolation method can be an arbitrary interpolation method such as a bilinear method, bicubic method, or spline method.

Then, the tonality estimation unit 1309 sets an initial value of 0 in an evaluation value E for evaluating tonality degradation (S1802), sets an initial value of 0 in a counter j (S1803), and calculates degradation D between tonalities in accordance with equations (17) (S1804):

ΔL=Lⱼ₊₁−Lⱼ;

D=|ΔL|; (17)

The tonality estimation unit 1309 compares the degradation D with a predetermined threshold x (S1805). If D>x, the tonality estimation unit 1309 determines that the degradation D is visually identified, and increments the evaluation value E (S1806). Note that it suffices to experimentally decide the threshold x. Further, the threshold x may be changed in accordance with the target luminance Lⱼ. For example, as the luminance becomes higher, it becomes more difficult for the human visual sense to discriminate a difference in luminance. Considering this characteristic, mLⱼ may be used instead of the threshold x using the luminance Lⱼ and a coefficient m (value of 0 to 1).

After that, the tonality estimation unit 1309 increments the counter j (S1807), and compares the value of the counter j with a predetermined value (255 in this example) (S1808). If j<the predetermined value, the tonality estimation unit 1309 returns the process to step S1804. If the value of the counter j has reached the predetermined value, the tonality estimation unit 1309 outputs the evaluation value E (S1809), and ends the evaluation processing.

The evaluation value E represents the number of tonalities at which degradation (reversal of tonality or a step of tonality) is visually identified. A larger numerical value represents larger tonality degradation. As the evaluation value E is larger, the personal profile generation unit 1305 brings the weight coefficient k closer to “1”, and decreases the degree of contribution of the luminance Lv₂ᵢ of the adjustment color patch 1204 after user adjustment. When the evaluation value E is small, the personal profile generation unit 1305 brings the weight coefficient close to “0”, and increases the degree of contribution of the user adjustment result.

As described above, the degree of contribution of the user adjustment result is changed by controlling the weight coefficient k in accordance with the result of evaluation by the tonality estimation unit 1309. In other words, the degree of correction based on the weight coefficient k can be controlled in accordance with the degree of degradation of the image quality by user adjustment.

### Modification of Embodiments

As the third embodiment, an example in which the return function is added to the color processing apparatus according to the first embodiment has been explained. However, the return function can also be added to the color processing apparatus according to the second embodiment.

Also, an example in which a device corresponding to a reference sample is, for example, an RGB printer and a device for outputting a color patch is a monitor has been explained. However, devices for acquiring a color matching relation are not limited to them. These devices may be, for example, image input/output devices such as a CMYK printer and projector.

An example in which the Lab value in the CIELAB space is used as a colorimetric value has been described. However, the colorimetric value may be an XYZ value in the CIEXYZ space, a Luv value in the CIELUV space, CIECAM97, or a Jab value in the CIECAM02 space.

The color matching data table generated according to the embodiment is used by an application which performs color matching between an input device and an output device. However, the function of generating a color matching data table may be assembled in a device as, for example, part of the calibration function. For example, the function of generating a color matching data table may be assembled in the calibration function of a monitor serving as an output device.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example through a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2012-276125 and 2012-276126 filed Dec. 18, 2012, and No. 2013-076457 filed Apr. 1, 2013 which are hereby incorporated by reference herein in their entirety.

What is claimed is:

1. A color processing apparatus for acquiring a color matching relation between different devices, the apparatus comprising:
a storage unit configured to store color information of a reference sample and a color characteristic of a display device;
a patch control unit configured to generate a plurality of color patch data having different colors based on the color information of the reference sample, and change at least some of the plurality of color patch data based on a user instruction; and
a patch output unit configured to correct the plurality of generated or changed color patch data based on the color characteristic of the display device to output the plurality of corrected color patch data to the display device,
wherein the patch control unit determines, based on a user instruction, whether to acquire a color matching relation in a combination of the reference sample and the color patch data, and
wherein, if it is determined to acquire the color matching relation, the color matching relation in the combination is stored in the storage unit by the patch control unit.

2. The apparatus according to claim 1, wherein, if it is determined to acquire the color matching relation, the patch control unit generates a plurality of color patch data corresponding to a next reference sample.

3. The apparatus according to claim 1, wherein the patch control unit determines whether acquisition of color matching relations in all combinations of the reference sample and the color patch data has completed.

4. The apparatus according to claim 3, further comprising a generation unit configured to, in a case where the patch control unit determines that acquisition of color matching relations in the all combinations has completed, generate personal color matching data of a user based on the acquired color matching relations.

5. The apparatus according to claim 1, wherein the storage unit stores reference sample data for printing the reference sample.

6. The apparatus according to claim 5, further comprising a reference sample output unit configured to output the reference sample data to a printing apparatus.

7. The apparatus according to claim 1, wherein the patch control unit generates, as the plurality of color patch data, color patch data of a center color which is the same as a color of the reference sample, and color patch data of peripheral colors each obtained by adding or subtracting a predetermined color difference to or from the center color.

8. The apparatus according to claim 7, wherein, in the display device, a color patch corresponding to the color patch data of the center color is displayed at a center of a plurality of color patches corresponding to the color patch data of the peripheral colors.

9. The apparatus according to claim 7, wherein in a case where the user instruction represents selection of the peripheral color, the patch control unit changes the center color to the selected peripheral color, and generates color patch data of the center color after the change, and color patch data of peripheral colors each obtained by adding or subtracting the predetermined color difference to or from the center color after the change.

10. The apparatus according to claim 7, wherein in a case where the user instruction represents selection of the center color, the patch control unit reduces the predetermined color difference, and generates color patch data of peripheral colors each obtained by adding or subtracting the reduced color difference to or from the center color.

11. The apparatus according to claim 10, wherein the patch control unit determines, based on a comparison between the reduced color difference and a predetermined threshold, whether to acquire the color matching relation in the combination.

12. The apparatus according to claim 11, wherein the threshold corresponds to a color difference of a display color that is occurred in a case where a signal value to be output to the display device is changed by one level.

13. The apparatus according to claim 7, wherein in a case where the user instruction represents that a plurality of peripheral colors have been repetitively selected, the patch control unit changes the center color to an average of the plurality of peripheral colors, reduces the predetermined color difference, and generates color patch data of the center color after the change, and color patch data of peripheral colors each obtained by adding or subtracting the reduced color difference to or from the center color after the change.

14. The apparatus according to claim 13, wherein the repetitive selection includes reciprocal selection of two peripheral colors, and cyclic selection of at least three peripheral colors.

15. The apparatus according to claim 1, wherein every time color patch data of the center color is generated or changed, the patch control unit holds the color patch data of the center color, and in a case where the user instruction represents return of a color of a color patch, generates the plurality of color patch data using the held color patch data.

16. The apparatus according to claim 1, wherein in a case where the user instruction represents exclusion of color patch data, the patch control unit acquires a color matching relation in the combination from remaining color patch data excluding the color patch data.

17. The apparatus according to claim 16, wherein the color patch data to be excluded comprises color patch data determined not to match a color of the reference sample.

18. The apparatus according to claim 16, wherein the color patch data to be excluded comprises color patch data determined to have a color difference between a color of the color patch data and a color of the reference sample falling outside an allowable range.

19. The apparatus according to claim 16, wherein the patch control unit acquires, as data representing the color matching relation, an average chromaticity of the color patch data not excluded.

20. The apparatus according to claim 1, wherein in a case where the user instruction represents an end of processing, the patch control unit acquires a color matching relation in the combination from color patch data selected by a user.

21. The apparatus according to claim 20, wherein the selected color patch data comprises color patch data determined to match a color of the reference sample.

22. The apparatus according to claim 20, wherein the selected color patch data comprises color patch data determined to have a color difference between a color of the color patch data and a color of the reference sample falling within an allowable range.

23. The apparatus according to claim 20, wherein the patch
control unit acquires, as data representing the color matching relation, an average chromaticity of the selected color patch data.

24. A color processing apparatus for generating a profile for making color appearances match each other, the apparatus comprising:
an acquisition unit configured to acquire brightness information and color information, wherein the acquisition unit refers to a first color signal and second color signal obtained in a case where a user determines that a reference color output from a first image output apparatus based on the first color signal and an adjustment color output from a second image output apparatus based on the second color signal match each other, and a storage device which stores a colorimetric value of the reference color and a colorimetric value of the adjustment color, acquires the brightness information of the reference color from the colorimetric value of the reference color, and acquires the brightness information and the color information of the adjustment color from the colorimetric value of the adjustment color;
a correction unit configured to correct the brightness information of the adjustment color using the brightness information of the reference color, and calculate a corrected colorimetric value of the adjustment color from the corrected brightness information of the adjustment color and the acquired color information of the adjustment color; and
a generation unit configured to generate, from the first color signal, the second color signal, the colorimetric value of the reference color, and the corrected colorimetric value of the adjustment color, a profile for making color appearances in the first image output apparatus and the second image output apparatus match each other.

25. The apparatus according to claim 24, wherein the correction unit sets a weight coefficient and computes, as the corrected brightness information of the adjustment color, a result of adding the brightness information of the reference color and the brightness information of the adjustment color at a ratio corresponding to the weight coefficient.

26. The apparatus according to claim 25, further comprising an estimation unit configured to estimate tonality degradation from the brightness information of the adjustment color,
wherein the correction unit sets the weight coefficient in accordance with a result of the estimation.

27. The apparatus according to claim 26, wherein the correction unit sets the weight coefficient to increase a ratio of the brightness information of the reference color as the result of the estimation represents larger tonality degradation.

28. The apparatus according to claim 24, wherein the correction unit performs the correction by replacing the brightness information of the adjustment color with the brightness information of the reference color.

29. The apparatus according to claim 24, wherein the profile makes a color appearance of a person in the second image output apparatus match a color appearance of the person in the first image output apparatus.

30. A color processing method of acquiring a color matching relation between different devices, the method comprising:
using a storage unit which stores color information of a reference sample and a color characteristic of a display device; and
using a processor to perform the steps of:
generating a plurality of color patch data having different colors based on the color information of the reference sample;
changing at least some of the plurality of color patch data based on a user instruction;
correcting the plurality of generated or changed color patch data based on the color characteristic of the display device to output the plurality of corrected color patch data to the display device;
determining, based on a user instruction, whether to acquire a color matching relation in a combination of the reference sample and the color patch data; and
storing, if it is determined to acquire the color matching relation, in the storage unit, the color matching relation in the combination.

31. A color processing method of generating a profile for making color appearances match each other, the method comprising:
using a processor to perform the steps of:
referring a first color signal and second color signal obtained in a case where a user determines that a reference color output from a first image output apparatus based on the first color signal and an adjustment color output from a second image output apparatus based on the second color signal match each other, and a storage device which stores a colorimetric value of the reference color and a colorimetric value of the adjustment color;
acquiring the brightness information of the reference color from the colorimetric value of the reference color;
acquiring the brightness information and the color information of the adjustment color from the colorimetric value of the adjustment color;
correcting the brightness information of the adjustment color using the brightness information of the reference color;
calculating a corrected colorimetric value of the adjustment color from the corrected brightness information of the adjustment color and the acquired color information of the adjustment color; and
generating, from the first color signal, the second color signal, the colorimetric value of the reference color, and the corrected colorimetric value of the adjustment color, a profile for making color appearances in the first image output apparatus and the second image output apparatus match each other.

32. A non-transitory computer readable medium storing a computer-executable program for causing a computer to perform the color processing method according to claim 30.

33. A non-transitory computer readable medium storing a computer-executable program for causing a computer to perform the color processing method according to claim 31.
